(19) United States
(12) Patent Application Publication
(10) Pub. No.: US 2012/0288845 A1
(43) Pub. Date: Nov. 15, 2012

(54) ASSESSMENT FOR EFFICIENT LEARNING AND TOP PERFORMANCE IN COMPETITIVE EXAMS - SYSTEM, METHOD, USER INTERFACE AND A COMPUTER APPLICATION

(76) Inventor: Umesh Kumar GL, Pune (IN)

(21) Appl. No.: 13/509,743

(22) PCT Filed: Nov. 15, 2010
(86) PCT No.: PCT/IN2010/000742

§ 371 Date: May 14, 2012

(30) Foreign Application Priority Data
Nov. 18, 2009 (IN) 1666/MUM/2009
Nov. 18, 2009 (IN) 1667/MUM/2009

(51) Int. Cl. G09B 7/00

(52) U.S. Cl. 434/362

(57) ABSTRACT

The invention comprises a computer assisted answer recording method for e-learning, or e-assessment comprising: (a) recording an answer choice by the user of the said method for an objective type question by an answer selection submitting input action or by a marking action made on an said answer choices' answer choice input receiving element, the said action being integrated concurrently with the same action with quantified parameters of the said users' means of arriving at an answer choice and reasons, feelings, thoughts & needs recorded simultaneously by the said user as and when they have arisen in the mind of the said user while solving the said question & choosing the said answer choice, and (b) feeding the said integrated input to a computer programme that would analyse the results and transform them into statistical indices of performance parameters in a quantified way in reference to the said question and said test information and display the said statistical indices to the user.

### FIELD OF INVENTION

The invention relates to improved process/method of e-assessment for evaluation of current knowledge of a user of the said method and for improvement in process of further learning and a system to support activities enabling successful task accomplishment in the aid learning or appearing for a test for assessment of his knowledge.

### BACKGROUND OF INVENTION

Assessment is an integral part of learning and is often described as serving two purposes: (1) measuring someone's performance (assessment of Learning e.g., standardised tests, summative tests); (2) helping the student for further learning (assessment for learning e.g., formative tests). An educational Assessment can be either paper based or online based (online based often called as an e-assessment or e-testing). The real value of an e-assessment platform is in its accurate assessment of a student's knowledge abilities, skill, personal traits, metacognition awareness; speed & accuracy with which it can enable a student realize his learning level, potential & areas for development for further learning. Many e-testing and e-assessment platforms attempt to provide assessment information of learning and assessment information for learning to the students by using conventional Multiple Choice Question (MCQ) format. A conventional MCQ format consists of a stem (content of question), 4 or 5 options (answer choices) and corresponding answer choice inputting or marking element (check box radio button) for each of the options to record the answer choice. Out of the 4/5 answer options only one of them is a correct one called as key. Other answer options which are wrong are called distracters. When presented with an MCQ, one needs to solve the question and pick the correct answer choice from the available options by clicking on the inputting element corresponding to the selected option, to input/mark his choice of answer. In some Graphic User Interfaces this action alone is taken as a confirmation of a user selecting and submitting an answer choice. In some GUI interfaces depending on the kind of assessment, one needs to submit the selected answer choice with one more click on a submit button to record his answer choice.

Many Students relay on e-assessment platforms for critical assessment of their knowledge, skills and abilities by answering mock tests as part of preparing for high stake exams. Mock test is a test conducted to imitate a final test, in terms of quality of questions and time constraints in answering a question. A student attending a mock test has some objectives like for example, (1) to know ones score and where does one stand among competition, (2) to assess if he is ready to take up the final test, (3) to understand the Knowledge, Ability, skill, personal traits and metacognition gap. Many e-testing & e-assessment platforms employ conventional MCQ Format for e-assessment as it is the most common, affordable & quick method used to asses a large number of students' mastery of Subject (assessment of learning) and also as it is also being widely used in high stake exams like Graduate Record Examination (GRE), Graduate Management Admission Test (GMAT), Scholastic Aptitude Test (SAT), American College Testing (ACT), Test of English as a Foreign Language (TOEFL) etc, students feel appropriate to use them. MCQ's are better applied at ‘assessment of learning’ rather than ‘assessment for learning’ as MCQ's are specifically designed for assessing the student mastery of a subject. It has a limited item level response input options that can only recognise if an answer choice is correct or wrong, which is just sufficient for assessment of Learning. The item level response data collected is limited and hence the evidence identification and accumulation process offered by conventional MCQ format is also limited and cannot be effectively used by a student for his further learning. Because of this the usage of conventional MCQ format is not efficient in giving ‘assessment for learning and top performance in competitive exams’.

The limitations of well known testing platforms that use MCQ format regarding ‘assessment for Efficient Learning and Top Performance’ are as follows: (1) The existing well known e-testing and e-assessment platforms does not tell students the Subject Areas/Question types that they need to attend immediately in order to stop losing their precious score. (2) The existing well known e-testing and e-assessment platforms cannot asses the familiarity of a subject/question type of a student in a single test. (3) The existing e-testing and e-assessment platforms are blind to the students' difficulties in answering a particular question. (4) The is existing well known e-testing and e-assessment platforms do not tell students when and where to stop spending their valuable preparation time in mastering a subject. (5) The existing well known e-testing and e-assessment platforms are time consuming in analyzing students capabilities, they want the student take ‘x’ number of tests before valid analytics can be produced. (6) The existing well known e-testing and e-assessment platforms do not measure the Metacognitive aspects of a student that enable them learn new knowledge efficiently. (7) The existing well known e-testing and e-assessment platforms do not monitor the common errors made by a student in solving various questions. (8) The existing well known e-testing and e-assessment platforms do not tell students if they are good at answering unexpected question types. (9) The existing e-testing and e-assessment platforms don't assess if a student is progressing in his preparation or is just static. (10) The existing well known e-testing and e-assessment platforms are not sensitive to gut factor of students. (11) The existing well known e-testing and e-assessment platforms are not sensitive to educated choices (guessing ability) of students. (12) The existing well known e-testing and e-assessment platforms are not sensitive to luck factor of students. (13) The existing e-testing and e-assessment platforms are blind to the student's perceived and realistic learning levels.

However the existing e-testing and e-assessment platforms using conventional MCQ format measures and conveys the correctness or incorrectness of the answer, student's performance of such questions over a period of time, time taken for answering questions and comparison of one's performance with others, and a report on a list of questions that were answered wrong or right, and expected score in the proposed final test etc. While this information gives some insights however it fails to provide crucial information that helps a student learn efficiently and get top result in an exam as discussed in the limitations of existing e-testing and e-assessment platforms above. While reviewing through the report students struggle to recollect the thought process, feelings, reasons and beliefs that have gone through or had arisen in their mind while picking that particular answer choice for a specific question. So they spend hours of time trying recollecting and understanding the mistakes they have done, reasons for making those mistakes or role of personal traits like educated guessing, gut picks and random picks that worked on their favour as ways alternative to gaining absolute mastery over the subject matter and other relevant information like should they rely on these alternative ways of answer picking or is gaining mastery over the subject matter is indispensable for them etc. With the inadequate information available from the existing e-testing and e-assessment platforms using conventional MCQ format and self imposed assumptions in trying to learn the reasons of the results of these tests, a students develop false beliefs on their personal traits, performance and subject mastery and carries false confidence. With this misinformation they make inappropriate decisions on learning methods, strategies and eventually on choosing the date of giving the final exam which later on puts a student in a disadvantageous condition.

Because of inaccurate and insufficient learning assessment, students are losing valuable preparation time, are confused and are under tremendous pressure in preparing for high stake exams. Because they are unable to get a reality check on their metacognition and accuracy on mastery of subject matter they are not able to use their complete learning potential in preparing for the exams. Hence they face a variety of problems during the final exam in spite of extensive preparation. For example, a case of an verbal ability exam of GRE can be considered and analysed. General problems faced by students during the exam are—(1) inability to recollect the correct meaning of word, though the word looks familiar, (2) word meaning confusion and the consequent nervousness in a time bound exam setup; (3) inability to decipher what sentences imply though the meaning of the word is known, (4) inability to retrieve synonyms and antonyms though the word is familiar, (5) inability to recollect the meaning of word, at the right moment. After answering couple of questions, the correct meaning of the word is realized but by then it's too late, as the computer based exams do not allow students to access previously answered questions, (6) inability to answer all questions with full effort within the given time limit because they have spent too much time in deciphering the meaning of some words they encountered in the question, (7) inability to use the correct test taking strategies in solving questions as they didn't have enough time to practice them during preparation period (8) the pressure gradually builds up and makes a student nervous because of which he would not be able to concentrate on other parts of the exam resulting in an overall poor performance.

It will be interesting to know that some issues at the time of preparation further lead to student's exam answering difficulties. For example in the case of vocabulary preparation where students who tried learning huge information (wordlists) in very short time (3-6 months) report problems such as follows: (1) Forgetting most of the learnt word meanings, (2) Getting confused with the learnt word meanings, (3) Inability to revise wordlists before exam, Revision before exam is key for easy access of learnt information during the exam, whenever required. Many students are unable to revise wordlists because it is not practical since it takes very long time; for example, assume revising wordlist from a regular workbook and sorting the correct and incorrect words for further learning/revising. Considering that it takes about 30 seconds per word, for revising 5000 words it takes about 40 hours or 5 days considering 8 hours per day. So students find it difficult to revise the wordlists before the exam having to give equal attention to all aspects of the exam like preparing and practicing for Quant and Analytical within the time available. (4) wasted time and effort, losing time & energy in figuring out the best learning strategy that works for them. (5). Inability to judge the priority of words that need to be learnt to stop loosing score. (a). Non availability of a proper tool for reality check on their vocabulary preparation many students become succumb to the false belief that they carry the correct meaning of words whatever they have learnt previously. However in reality they might be carrying a wrong understanding of a word. These are very dangerous words as when encountered they would confidently pick an answer based on their false understanding, and jeopardizing their scope for getting more marks. Some exams like GRE which are computer adaptive decide the standard of a student based on the students responses for the first 3-5 questions. So it is very important for students to make sure whatever words they have learnt, they are carrying the correct understanding. If not they need to attend to those words first before learning new words. (6). Not knowing when and where to start and stop learning new words. (7). Not having a control on amount of time they spent in a day for learning vocabulary.

During the test preparation, they have spent too much time learning vocabulary and were left with little time to practice the test strategies. So this made them to answer the test ineffectively attributing to score lesser than their actual capability. As the time approaches for the final exam the burden of remembering data increases and when they face situations when they are unable to recall the correct word meaning in spite of tremendous hard work they have taken up to learn it in the past, feelings get worsened and tension builds up. Not knowing how to overcome this despairing situation, students desperately search for various alternative ways of accomplishing the result. Many students at this stage give up on mastery and resort to assuming, hoping and believing to do their best in the final exam. With increasing pressure one would lose composure and in spite of ones hard work done in learning one would succumb to doubt and fear. A natural consequence of such failed task accomplishment attempt is faced in the final moments of the actual exam resulting in poor score.

Learning is a complex task consisting of many interrelated activities. Learning for achieving a task in limited time, for example excelling in a standardised test, is a stressful task consisting of developing appropriate metacognition, beliefs, realistic confidence and carefully planning ones time and energy. Trying to achieve two or more tasks at the same time is an even more tiring and uninspiring task where the student's only ambition would be to accomplish the task in one attempt successfully with his best capabilities. Typically students are faced with the situations where they are giving various multiple standardized tests within short span of preparation in anticipation of getting an entry to various exciting careers. They need to accomplish this along with studying for academic examinations. So, students are trying to be strategic and smart in doing learning activities that would help accomplish the task in minimum time and effort by carefully balancing one's mastery and performance orientations. A student with mastery orientation has the tendency to master the finer aspects of the subject matter, giving less importance to performance, believing that once mastered, one would automatically do well in the exam. But they fail to realise the limitations posed by the available time and often fail in their approach. On the other hand a student having a performance orientation would try his best to achieve success in the exam with minimum mastery, in most cases they do fail as alternative methods like educated guessing, gut picks or random luck picks would alone not be sufficient for exam success. So a careful balance is to be maintained between one's mastery and performance orientation. But students are not able to develop required awareness on their personal traits and metacognition with the tools currently available to them for choosing best task accomplishment activities.

Hence there is a need for a better method and system of ‘e-assessment for efficient learning and top performance in exams’ that addresses the needs of students in accomplishing a task successfully, right from knowing or realising one's knowledge, ability, skill, personal traits and metacognition to actually utilising them with full potential for successful accomplishment of the said task quickly, effectively and easily in a comprehensible way for students worldwide.

### SUMMARY OF INVENTION

The invention comprises a computer assisted answer recording method for e-learning, or e-assessment comprising steps of: (a) recording an answer choice by the user of the said method for an objective type question by an answer selection submitting input action or by a marking action made on an said answer choices' answer choice input receiving element, the said action being integrated concurrently instantly with the same action with quantified parameters of the said users' means of arriving at an answer choice and or of reasons, feelings, thoughts, & needs recorded simultaneously or instantly by the said user as and when they have arisen in the mind of the said user while solving the said question & choosing the said answer choice, (b) feeding the said integrated input to a computer programme that would analyse the results and transform them into statistical indices of performance parameters in a quantified way in reference to the said question and said test information and display the said statistical indices to the user automatically or as and when desired by the user.

In one aspect of the invention, the said answer choice input receiving element, displayed in the graphic user interface for the said answer choice can be any one or more of following: (a) of any shape, word, sentence, numerical, 3d form; colour, value, sound; (b) displayed with other answer choices' input receiving elements of the said question, or with other input receiving elements of the Same answer choice for the said question where in, each of the said one or more said answer input receiving elements can represent a means or type of answer pick corresponding to educated guess pick, random pick, gut pick, logic pick, confident pick, revision required pick or no response pick, (c) arranged in any visible formation within the displayed graphic user interface, where in the visibility value can be set to any value between zero, meaning invisible or 1 meaning fully visible, inclusive, and the said visibility state can be changed by movement of a cursor on the displayed said GUI or by pressing keys on the key board. Data generated by the computer for further use of the user through above method of answer choice input is one embodiment of this invention.

In another aspect of the invention, the said integration of the said parameters with the said answer with the said answer selection inputting or marking action is achieved by encoding of Graphic User Interface (GUI) answer choice input receiving elements or by encoding various keys in the keyboard or by encoding of cursor movements on the GUI or by encoding a combination of GUI answer choice input receiving elements & various keys in the keyboard with quantified parameters, and integrating the said chosen parameters by the said user with the said answer selection inputting action that records the said users' answer choice and or by a an action made by the said user for selection of the specific parameters.

In a further embodiment of this invention, the said answer recording method is used on a GUI comprising means for said answer recording method alone or at least one or more of the question stem or answer choices or answer choices input marking elements or tag names of selected parameters or progress indicators or space for adding personal notes or a display of information like text, picture, voice or video.

This invention also comprises a method of learning for or of accomplishing a task by user of the said method comprising (a) a means for developing self evaluation on the said task by the said user, (b) a means for verification by the software of statistical analysis embedded in the computer of the validity of the users' task self evaluation and displaying the ground reality in the form of statistically analysed indices, identifying possible ways of improvement in terms of improvement in mastery over the subject matter or prospects of success in reliance on alternative personal traits of the user including educated guess ability, gut factor and luck factor, (c) a means for displaying projections prepared by the computer on various prospects or opportunities the said accomplishment of the said task would provide to the said user as a means to motivate the said user to accomplish the said task successfully, (d) a means for enabling the said user in conducting and repeating the self evaluation, learning activities, testing his preparedness by undertaking an e-assessment of claim 1 to improve upon the relevant shortcomings and weakness, (e) a means for equipping the said user with validated and quantified assessment of his preparedness for performing the said task in an examination or a performance of his knowledge in real life. The said task may comprise use or performance of at least one of the user's task relevant subject matter comprising his existing Knowledge or Ability or Skill or Aptitude or personal traits or Metacognition awareness or metacognition regulation; the said self evaluation may pertain to one or more of (i) the said users' own capability, (ii) state of preparedness to accomplish the task, (iii) user's perception on how and when a task is conducted, (iv) user's perceived likelihood of accomplishing success, (v) user's perception on different means of learning and performing activities available for accomplishing the task.

In yet another aspect, method of this invention comprises at least one of the following:

(a) a means for e-assessment comprising steps of (i) accessing the participating e-testing and e-assessment platforms' relevant question databases and generating the mock test based on users' selection of exam, (ii) displaying to the said user a GUI enabled with the said answer recording method, (iii) presenting a question to the user, (iv) receiving an answer choice by the said user comprising the method as recited in the process of recording the said answer choice by the said user by a answer selection inputting action or marking action through an inputting device wherein the inputting or marking action is also integrated with the said users' own thought process comprising of beliefs of his own or psychological preparedness or a need thereof, the reasoning behind choosing the said particular answer prior to or at the time of recording the said answer choice by the said users' inputting action; (v) decoding of the response input by the said computer and storing it in the said database and making it available for the respective e-testing and e-assessment platform; or
(b) a means for Metacognition validation comprising steps of (i) recording of a set of a users' collective expectations and projected thoughts of the potential outcome of the said activity before conducting the said activity, (ii) enabling conducting of the said activity by the said user, (iii) If the said activity is of learning then conducting an e assessment as recited in claim 8.a to the said user for collecting the users' responses on questions pertaining to the said activity, (iv) collecting the expectations and thoughts of the outcome on the already completed said activity, (v) receiving and storing the said information on a database, (vi) comparing the difference in expectations and projected thoughts of the said user from the statistically analysed conclusions and indices from the collected data, (vii) further comparing the said comparison with the said data collected from the said individual question answer responses recorded by the said user if available, (viii) conveying the said difference by the computer to the user by means of indicators representing difference in the expectations of the user of his beliefs or metacognition and the ground reality calculated by the computer in the said activity and said task pertinent subject matter; (ix) further, conveying the related recommendations to the said user regarding present as well as future task pertinent activities to achieve improvement over the identified shortcomings; or (c) a means for Metacognition development comprising: (i) displaying of indicators and recommendations to the user like educated guess ability, luck factor, gut factor, subject thoroughness, exam readiness, Trust your gut Recommendation and subject matter improvement strategy determination derived from the data recorded during various assessment activities conducted by the said user; (ii) based on the said indicators displaying of subject matter segregated into knowledge contents that are classified into unknown, vantage, decayed, danger, known, mastered and aced group categories; (iii) displaying a suggested ratio required to be maintained between acts resulting in mastery and expertise of the subject matter and the acts resulting in circumventing the need of mastery and expertise of the subject matter to achieve the said task by the said user; (iv) receiving of the said user's input about the said ratio and updating the said segregated groups of subject matter along with available activities for the said user to conduct and achieve the expected outcome of the said task; (v) enabling the user to conduct said related activities; (vi) tracking, monitoring, analysing the user's said related activities to calculate the improvement achieved and conveying it back to the said user; (vii) repeating the steps till the user accomplishes the said task, or
(d) a means for warm-up session activity/method conducted a few hours before performing the said task to achieve the said anticipated outcome of the said user in the said task, comprising of: (i) receiving the criteria for warm-up including the time available for performing the said activity; (ii) determining the data to be shown to the said user based on the available time and criteria for warm-up set by the said user, (iii) displaying to the user a set of comprehensive interactive information, the said interactive information may comprise of the said user interacting with the said interactive information through a GUI using an input device, for getting more insights, on his achieved subject matter so far by various activities the said user has performed by accessing from the said users' database; (iv) receiving an input from the said user confirming the said users' satisfaction level; (v) displaying the subject matter to be reviewed few hours before the said task by the said user as determined by a set of algorithms and presented to the said user by means of a set of activities like timed quizzes; (vi) on completion of the said activities, displaying to the said user, information strengthening and boosting the said users' Metacognition and confidence in helping the said user to approach with a realistic confidence to perform the task successfully, or
(e) a means for the user to develop task awareness of the said task comprising: (i) receiving from the said user, the said users' criteria, the said criteria may comprise of academic qualifications, accomplishments and interests; (ii) on receiving the said inputs displaying the said user a GUI containing possible list of tasks suitable for the said users' said criteria, (iii) receiving from the said user a selection of new task from the said displayed list of tasks; (iv) on receiving the said user selection, accessing the said users' database to generate the said users' said task related task readiness indicator along with the relevant said users' possessed subject matter and possible list of activities to achieve the said selected task and a list of relevant said task related information, for the said user's further exploration; (v) receiving from the said user an input for further exploration and launching the said users' selected activity; (vi) storing all of the said User generated activity related data and input data in the said user database, or
(f) a means for a user to instantly build subject matter awareness on a symbol or numerical or character or shape or word or a diagram or a picture, or a group of symbols/numerical/character/shape/word/diagram/picture comprising carrying a machine readable encoding displayed to the said user on a GUI connected to the network system, while performing an task related activity, the said means comprising: (i) displaying of Pop up window on the onset of the said user clicking on a symbol or numerical or character or shape or word or a diagram or a picture, or a group of symbols/numerical/character/shape/word/picture/diagram carrying a machine readable encoding, appearing anywhere within the said plurality of GUIs connected to the said network system from the said user, (ii) displaying pertinent information related to the said symbol or numerical or character or shape or word or a diagram or a picture, or a group of symbols/numerical/character/shape/word/picture/diagram in the pop up window; (iii) receiving and recording custom content created or uploaded by the said user related to the said symbol or numerical or character word or shape or a group of symbols, numerical character, word; carrying a machine readable encoding, (iv) saving the new information in the said users' database; (v) retrieving and displaying the recorded information to the said user in future on the said user's explicit request, or
(g) a means for facilitating the said user conduct the said task related offline activities or online activities through the said network system, comprising: (i) displaying a GUI containing visually represented groups of data containing the said task and the said user's pertinent subject matter with indicators, task related information, associated inbuilt and third party activities applications; (ii) receiving various task and activity pertinent inputs either from the said user or from the said user's tutor or an algorithm, (iii) updating the said groups of data dynamically; (iv) receiving an input from the said user as a selection on one of the said displayed activities for a said group of data; (v) launching the said activity enabling the user to perform the said activity with related groups' subject matter; (vi); monitoring the user activity; (vii) updating the said groups of data based on the outcomes of the said activity by the said user; (viii) Indicating a visual prompt, generated by a algorithm considering the said users' said mastery and performance ratio, on one of the said groups of data attracting users' attention for the next proposed said task based activity.

### BRIEF DESCRIPTION OF THE DRAWINGS

Various attributes shown in the drawings are non limiting examples for the purpose of explaining working of the invention and in no way they limit the scope of the invention or claims. They can be replaced by equivalent and alternative embodiments that are within the scope of the claims.

FIG. 1: Illustrates a typical default layout for the disclosed typical Assessment Graphic User Interface with.

FIG. 1A: Illustrates different items in a typical test GUI.

FIG. 2: Illustrates the default input grid formation displayed whenever a new question is presented to a user prompting for the answer. Notice, the first column of inputting circles in the grid formation is highlighted in bold black colour outline. Also notice the Pick type tagline for the first column indicated below the input grid formation and is read as “confident Pick”.

FIG. 3: Illustrates the cursor is on the second column of the input grid formation and the inputting circles or elements in the column are highlighted in bold black colour outline. The Pick type tag line reads—“Revision Required Pick”.

FIG. 4: Illustrates the cursor is on the third column and that column s′ inputting circles or elements are highlighted in black bold outline. The Pick type tag line reads—“Educated Guess Pick”

FIG. 5: illustrates the cursor is on the fourth column and it 0 inputting elements are highlighted in black bold outline. The Pick type tag line reads—“Random Pick”.

FIG. 6: Illustrates the “not familiar” tag line appearing below the Pick type taglines, whenever the user presses and holds down a preset key on the key board, while selecting an answer. Notice the confident pick column is highlighted even if the cursor is not on it as highlighting the confident pick column is a default setting.

FIG. 7: Illustrates the “Gut” tag line appearing below the Pick type taglines, whenever the user presses and holds down a preset key on the key board, while selecting an answer. Notice the educated pick column is highlighted as the cursor is directly on it.

FIG. 8: Illustrates the “Not Familiar+Gut” tag line appearing below the Pick type taglines, whenever the user presses and holds down the relevant preset keys together on the key board, while selecting an answer.

FIG. 9: Illustrates one of the input grid formations, as shown to a user prompting for the answer. Notice the circle column on which the cursor is, becomes bold and black. Other circles in other columns remain grey, thin outer line.

FIG. 10: Illustrates the default input circles grid, whenever a new question is presented to a user prompting for the answer, who has opted for “do not display tag line”.

FIG. 11: Illustrates one of the input circles grid in concise format, whenever a new question is presented to user who is well aware of the inventive GUI, opting for a less clustered input display.

FIG. 12: Illustrates one of the input circles grid in concise format, whenever a new question is presented to user who is well aware of the inventive GUI, opting for a less clustered input display and no tagline display as well.

FIG. 13: Illustrates one of the input method without grid formation, displayed whenever a new question is presented to a user who is well aware of the inventive GUI, opting for a no input grid formation display.

FIG. 14: Illustrates a typical Inventive GUI, when the immediate feedback mode is set to “OFF”. The picked circle turn into a grey star acknowledging the logging of answer input and displays the next question.

FIG. 15: Illustrates a typical Inventive GUI, when the Immediate feedback mode is set to “ON”. When a user selects a correct answer, the picked circle turn into a star acknowledging the logging of correct answer input and then displays a tick mark against the correct answer choice, after a user preset timing the next question is displayed.

FIG. 16: Illustrates a typical Inventive GUI, when the Immediate feedback mode is set to “ON”. When a user selects a wrong answer, the picked circle turn into a cross acknowledging the logging of wrong answer input and then displays a tick mark against the correct answer choice. After a user preset timing the next question is displayed.

FIG. 17: Illustrates a typical Inventive GUI, when the Immediate feedback mode is set to “ON”. When a user selects a wrong answer, the picked circle turn into a cross acknowledging the logging of wrong answer input and then if there is any related personal notes created by the user, that information is displayed and then prompts the user to re-select any one of the remaining answer choices.

FIG. 18: Illustrates a typical Inventive GUI, when the Immediate feedback mode is set to “ON”. When users first selected answer is wrong, related personal notes is displayed and the user makes a second pick and the second pick turns to be correct one.

FIG. 19: Illustrates a typical Inventive GUI, when the immediate feedback mode is set to “OFF”. When a user opts for Gut Pick and selects 2 answer choices, the first pick is a gut pick and is represented with letter G encircled and the second Pick is by his logical deduction represented by a grey star. After a user preset timing the next question is displayed.

FIG. 20: Illustrates a typical Inventive GUI, when the Immediate feedback mode is set to “ON”. When a user opts for Gut Pick and selects 2 answer choices, the first pick is a gut pick and is represented with letter G encircled and the second Pick is by his logical deduction represented by a grey star. If the Gut pick is the correct choice, the corresponding answer is highlighted by a tick mark and the second pick turns to a cross.

FIG. 21: Illustrates a typical Inventive GUI, when the Immediate feedback mode is set to “ON”. When a user opts for Gut Pick and selects 2 answer choices, the first pick is a gut pick and is represented with letter G encircled and the second Pick is by his logical deduction represented by a grey star. If the second pick is the correct choice, the corresponding answer is highlighted by a tick mark and the second pick turns to a star.

FIG. 22: Illustrates a typical Inventive GUI, when the Immediate feedback mode is set to “ON”. When a user opts for Gut Pick and selects 2 answer choices, the first pick is a gut pick and is represented with letter G encircled and the second Pick is by his logical deduction represented by a grey star. If both the picks are wrong choice, the corresponding answer is highlighted by a tick mark and the second pick turns to a cross.

FIG. 23: Illustrates a typical inventive GUI, when the swap mode is active, the correct answer for a question takes place of the question word or sentence and 5 different question words or sentences are appeared in the place of answer choices. The user will have to find the correct question to the given answer choice.

FIG. 24: Illustrates a table with 41 unique responses—possible test outcome from any question by using the inventive GUI disclosed in this specification.

FIG. 25: Task Accomplishment Methodology

FIG. 26: Illustrates the typical environment or set up where the disclosed system and methods are applied and used.

FIG. 27: Illustrates Unique Dynamic Personalised (UDP) wordlist layout.

FIG. 28: Illustrates a typical Task setting applet GUI.

FIG. 29: Illustrates 4 different columns from UDP wordlist table showing different activities relevant to respective columns, displayed when the cursor is hovered on individual column.

FIG. 30: Illustrates representation of word power index Indicator.

### DETAILED DESCRIPTION OF THE INVENTION

For the convenience of explaining various disclosed embodiments of this invention, where ever applicable, suitable subject matters and numerical values are taken for illustrative purpose. However a person in the field of education can easily relate and appreciate this to a wider application of different subject matters as well.

At micro level, meaning during the time of a user solving a problem in a mock test, the user would be able to record crucial information that helps him develop metacogniton by quickly inputting his thoughts as and when they arise in ones mind during the problem solving of the given question. As the recording happens simultaneously and instantly, the user will not be under pressure to recollect the means of arriving at the answer choices, reasons, thoughts, beliefs and needs that have aroused during the mock test, later on when he wants to understand the reasoning behind his specific chosen answer choices. This also helps him to conduct review and summation effortlessly and quickly. The explicitly recorded data when analysed by a computer programme would give rich accurate and finer insights to the user on ones exam related subject matter like existing Knowledge or Ability or Skill or Aptitude or personal traits or Metacognition awareness or metacognition regulation.

In one embodiment such answer recording method is achieved by use of different types of Chosen answer choice markings or picks. A typical user arrives to an answer choice for a question by various means and methods that can be identified into some specific types, for example and not limited to, Confident Pick indicates that the user is confident about his answer choice and he is comfortable in answering such questions about the given content. Here the answer choice is derived by direct deduction by applying formulae or logic or recall or the like. Revision Required Pick indicates that the user is confident about his answer yet he wants to review or practice more of them. Here as well the answer choice is derived by direct deduction by applying formulae or logic or recall or the like. Educated Guess Pick indicates that the user has arrived at an answer choice by educated guessing by the process of elimination or the like. Random Pick indicates that the user has arrived at an answer by randomly picking one. Gut Pick indicates that the user has arrived at a probable answer by direct deduction but his instincts point him to choose a different answer. Logic Pick indicates that the user had derived to the answer by calculation but is doubtful and is generally preceded by the Gut pick.

Such different types of answer choice markings or picks are integrated with quantified parameters of reasons, feelings, thoughts and needs that have arisen in the mind of the user while solving the said question & choosing the said answer choice such reasons, feelings, thoughts and needs can be any one of the following and not limited to Reason for choosing the said answer choice type (An underlying fact or cause that provides logical sense for a premise or occurrence) like ‘Familiarity’ indicates one is familiar with both question type and content. ‘Unfamiliarity’ indicates one is not familiar with both question type and content. ‘Unfamiliar Question type’ indicates one is not familiar with only the question type. ‘Unfamiliar Content’ indicates one is not familiar with only the content. ‘Forgotten’ indicates one is not able to recollect a strategy, formulae, and concept, word meaning etc. Lack of time to solve the problem etc; Feelings (An affective state of consciousness, such as that resulting from emotions, sentiments, or desires, An emotional state or disposition; emotional or moral sensitivity) like Nonchalant, Extreme Pressure, Happy Go lucky/enthusiastic, Moody, Doubtful, Tensed, Bring it on/Challenging Spirit, Optimistic mood, Pessimistic mood, Tough, Tensed, Easy, Joyful, and the Like; Thoughts (The intellectual activity or production of a particular time or group; the act or process of thinking; deliberation, meditation, or reflection) solving an objective question consists the step of but not limited to (1) Reading the question for the purpose of understanding it, (2) deciding on the strategy to solve it, (3) Applying the strategy to Solve it, (4) Deriving an answer and Reassuring one has the right answer, (5) Picking the answer choice from the available options. Various thoughts would occur at each of the steps for example ‘i think i should solve this question carefully’ is my answer choice correct? ‘ah, this is tough, i can't understand the question’ etc.; Needs (what is required by the user as an action succeeding the picking of the answer choice; necessities) need for further study, need for hints, need for answer feedback, need for developing more clarity, need for conducting more practice etc.

The user would be able to record several of one or more of these said parameters together using the said answer recording method. This can be achieved in many ways, for example by marking or inputting an answer choice input receiving element encoded with the afore mentioned parameters. One exemplary method of encoding of the various answer choice selection marking input elements is described. The following exemplary embodiment is been narrated for illustrating the encoding of inputting elements to enable a user record answer choice as discussed in this specification, using one out of many different possible ways in which the same may be achieved by a person skilled in art; and hence illustrated example should not be seen as a limitation of possibilities or its intended functioning. For example each of the answer pick type is assigned a value like confident pick parameter is assigned a value of 000001. Revision required pick parameter is assigned a value of 000010. Similarly each of 5 answer choices are also assigned a value, for example, answer choice B is assigned a value of 00010. Similarly various afore mentioned parameters pertaining to the variety of user thoughts, needs, beliefs etc are encoded, for example Familiarity parameter is assigned a value of 001. Unfamiliarity parameter is assigned a value of 010 etc. these encoding is added together to generate a multi digit code. For example If a user is picking an answer choice B by means of revision required pick, then a multi digit code representing this combined parameter encoding is generated as 000010-00010. If the user has decided to choose the unfamiliarity value, then the said Unfamiliarity, a value of 010 is added to the multi-digit code automatically. The multi digit code now would be 010-000010-00010. If the user decides not to record the unfamiliarity then the 010 value is automatically taken away from the multi digit code. Other answer related encoding like the response time along with question and answer information encoding are added to this multi-digit code pertaining to the answer choice inputting element at the time of user marking his chosen answer choice. Once the user clicks the chosen answer choice input element, this multi digit code is recorded as his answer choice for the particular question, into the database. Once the multi digit code is recorded all the enabled parameters would be reset to their respective default settings. Specially designed algorithms can be used to analyse the recorded data for generation of Indicators, analytics and interactive visual database indicative of the individual's as well as collective student performance of an exam, which are discussed further in this disclosure.

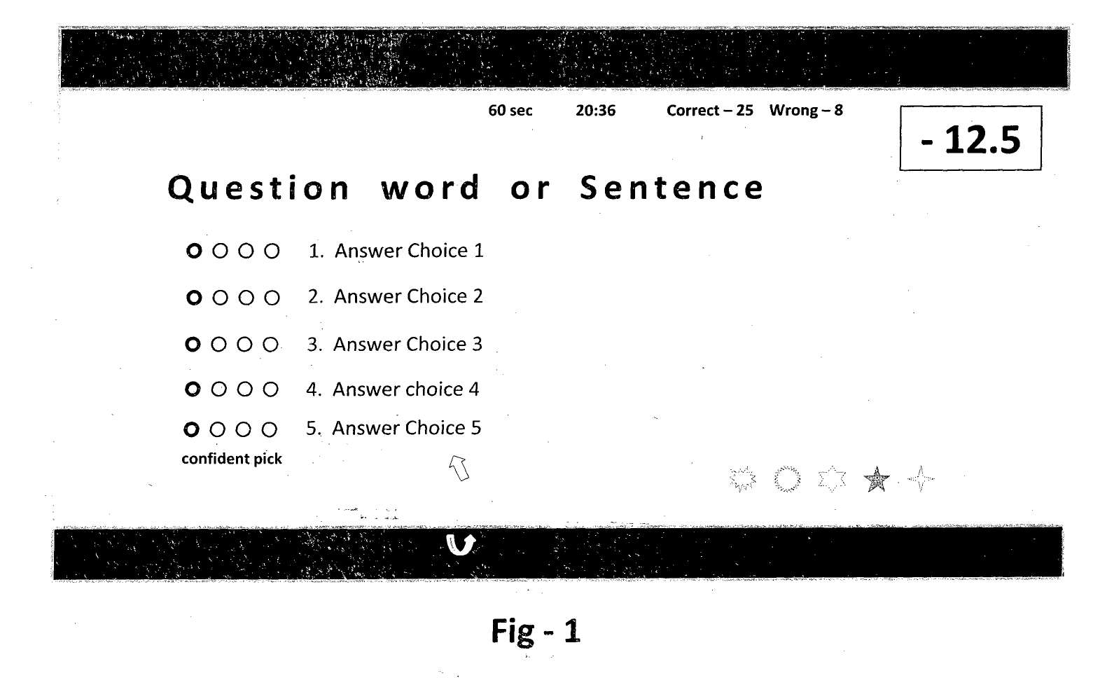

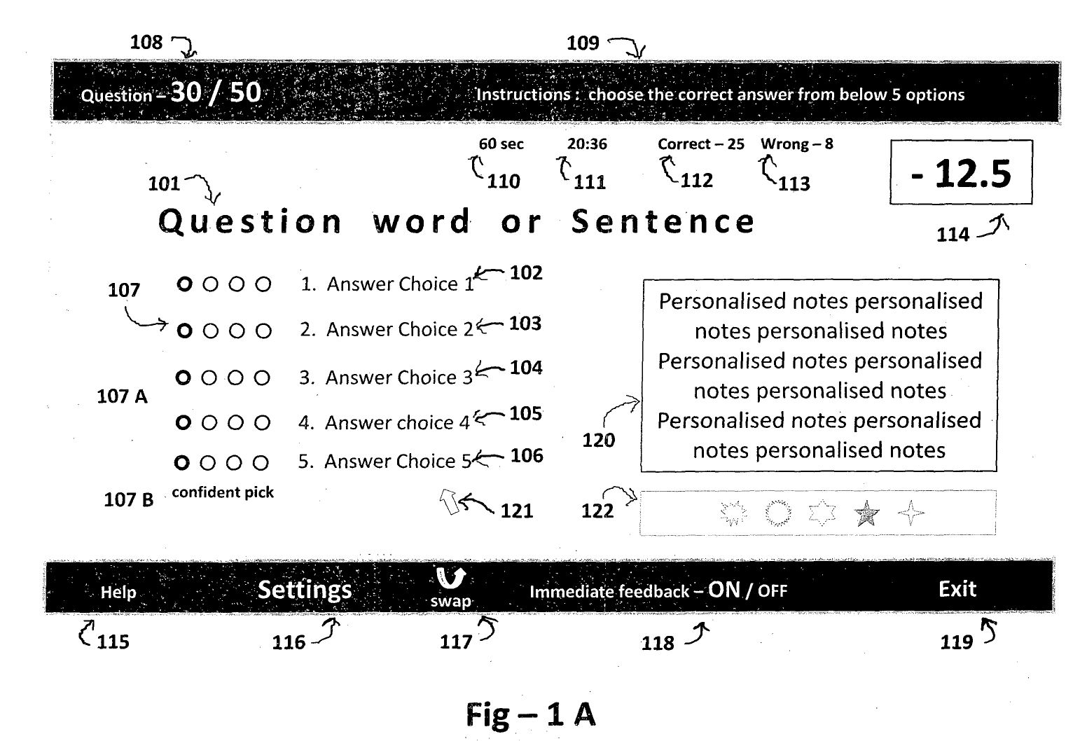

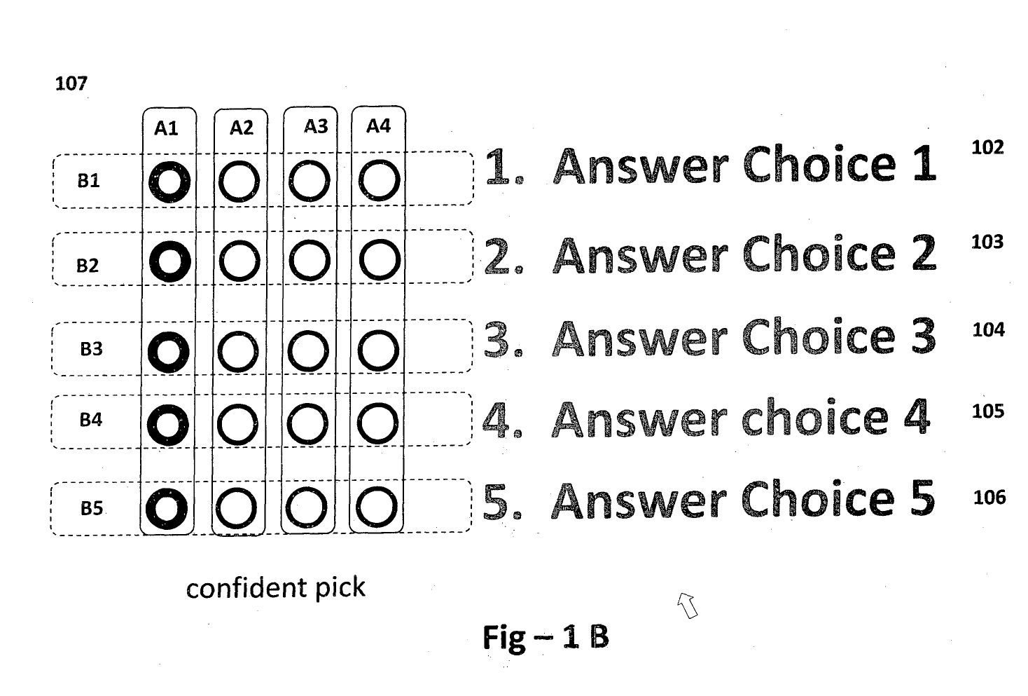

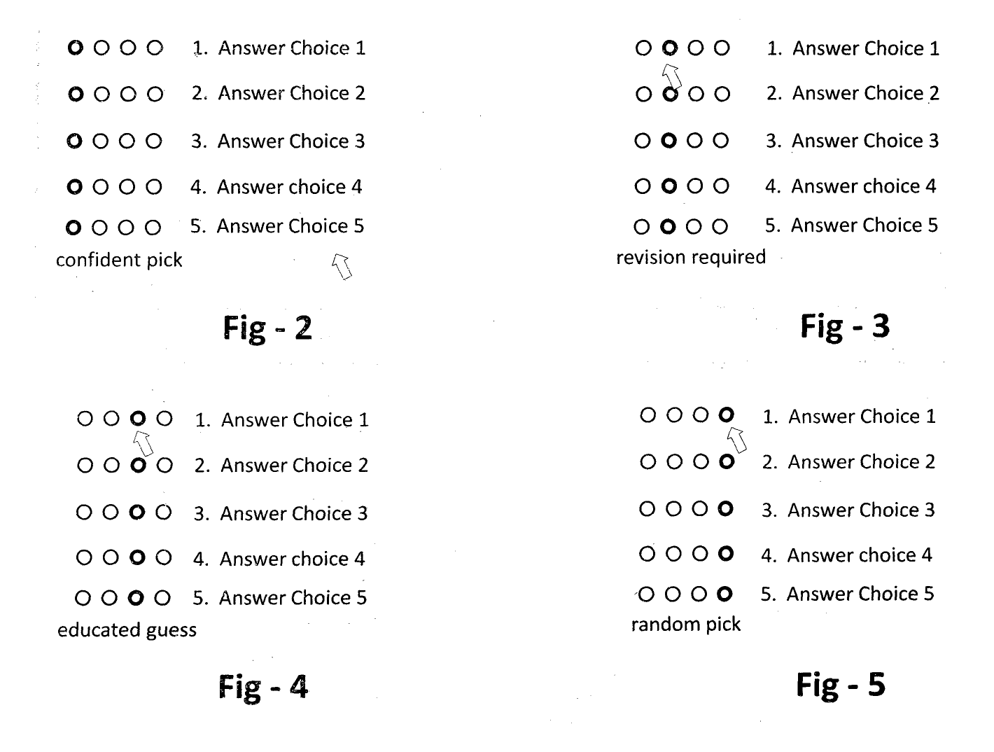

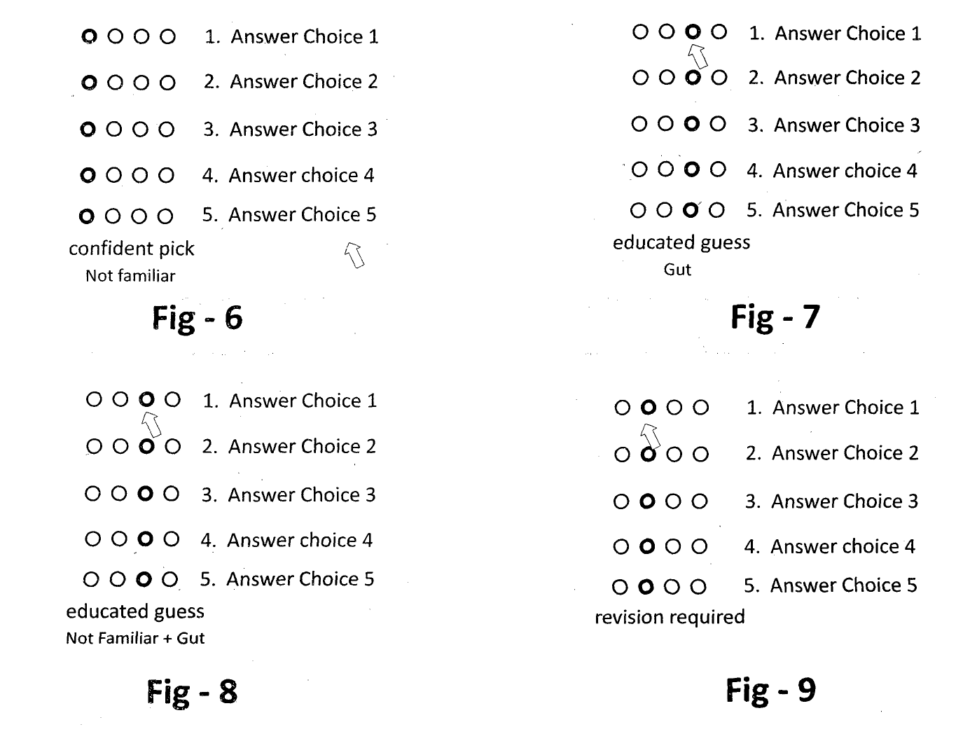

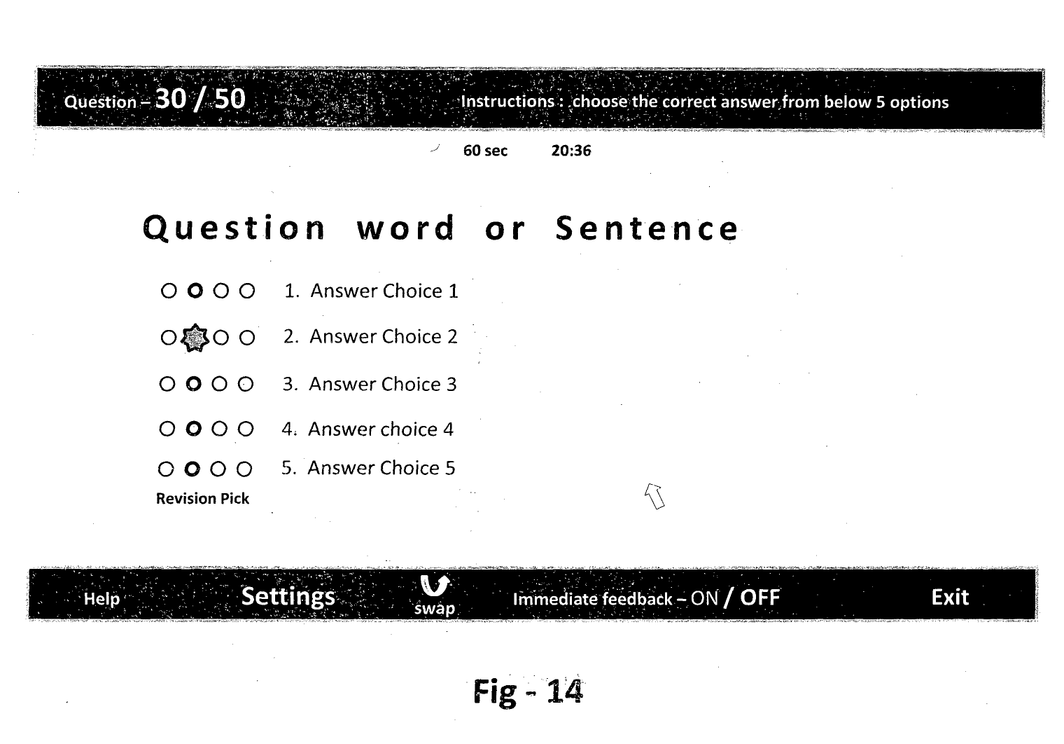

Such encoded elements needs to be organised and displayed to the user in a thoughtfully planned layout so that the user can mark one of the input elements corresponding to the displayed answer choices, with ease and accuracy. One exemplary method of visual formation of various answer choice selection marking input elements is described in: answer choice selection inputting or marking input elements visual formation (107) FIG. 1A & FIG. 1B. This formation is used by the user primarily to mark an answer choice. Each of the element has the ability to collect the means of arriving at an answer, reasons, feelings, thoughts and needs that have arisen in the mind of the user while solving the said question & choosing the said answer choice The default said visual formation consists of a 4×5 circle matrix, in which each of the circle acts as an answer choice input receiving element. The said input receiving elements are encoded with some predefined, active and latent parameters, where in predefined can mean the parameters set by the user or tutor for collection of data as default; active meaning, the parameters are recorded without the user having to explicitly enabling them; latent meaning the parameters that are existing in dormant form and are required to be enabled for the purpose of recording. The input receiving elements are grouped under 4 different columns A1, A2, A3, and A4 of FIG. 1 B. Each of the 5 circles in these 4 columns corresponds to the 5 answer choices (102, 103,104,105, and 106) that they are in line with. For example, the circles in row B1 of columns A1; A2, A3, A4 corresponds to the answer choice 102, similarly row B2 corresponds to 103, row B3 corresponds to 104, row B4 corresponds to 105, row B5 corresponds to answer choice 106. Let us say in an example question the user has arrived to an Answer choice 3 (104) as his preferred answer choice, then he would pick one of the inputting circles from the corresponding row B3. Furthermore each column (A1, A2, A3, A4) is assigned a specific value to determine the type of answer pick. The first column circles A1 is assigned to ‘confident pick’ value. The second column A2 is assigned to ‘revision pick’ value. The third column A3 is assigned to ‘educated guess pick’ value, the fourth column A4 is assigned to ‘random pick’ value. To make the inputting grid and element selection more interactive a user can assign specific colours to each of the columns. For example confident pick inputting elements can be assigned a green colour, so that when ever the cursor moves onto the particular column all the inputting elements of the column would be highlighted in bold green colour outline. When the cursor or pointer hovers on these columns, the respective column on which the pointer is, will be highlighted in pre-assigned bold colours and at the same time a tag line representing the specific value of the column is displayed at the bottom of the column, to convey to the user what type of answer pick the column is for. The other columns on which the cursor is not placed will be receded to their default un-bold colour outline, for example thin black outline. For the purpose of illustration in this specification, the highlighted column inputting elements are mentioned to be possessing back bold outline shapes, the un highlighted column inputting elements are mentioned to be possessing black thin outline shapes. When the user is presented with a new question and 4/5 answer choices, by default the first column inputting circles elements are highlighted in bold black colour outline with the “confident pick tag” FIG. 2. When the user moves his cursor onto any of the other 3 columns the respective circles in columns get highlighted and relevant taglines are displayed at the bottom of the column automatically. This dynamic animation of columns and respective tags can be well appreciated in FIGS. 2, 3, 4 and 5. To ascertain the user that his answer input has been registered by the system, a visual feedback is given by turning the picked circle to a grey star FIG. 14. The input grid formation 107 is also assigned certain latent parameter values related to specific functions, that would become active by pressing and holding default or user customised buttons. For example pressing and holding the default ‘SHIFT’ button would activate the function value “Unfamiliarity” this activation is represented visually to the user by displaying “not familiar” tag below the column at specific tag line box FIG. 6. By pressing and holding the CONTROL button on the key board would activate “GUT pick” functionality to the input grid formation FIG. 7. As and when the user releases pressing and holding the default buttons, the respective functionalities would be activated. The user can customise these default button settings by clicking on the setting button (116) on the test GUI. This can be done any time before, during or after the test.

Some of the different type of explicit ‘answer picks’ available for the user through the disclosed GUI in its basic visual formation format for a student to pick from are as follows—1. Familiar, confident pick. 2. Not Familiar, Confident Pick. 3. Familiar, Revision Required Pick. 4. Not familiar, Revision Required Pick. 5; Familiar, Educated Guess Pick. 6. Not Familiar, Educated Guess Pick. 7. Familiar, Random Pick 8. Not Familiar, Random Pick. 9. Familiar, Gut Pick followed by logic pick. 10. Not familiar, Gut pick followed by Logic pick.

Explanation of exemplary embodiment of displaying the assessment GUI containing the said answer recording method. A user who is seeking an e-assessment for a test online/offline is presented the disclosed test GUI as shown in FIG. 1 on a computer screen/I pad/net book or any other device he is using. The GUI interface would consist of the following: An area for displaying test content consisting of Stem having a question word or sentence (101) and 5 answer choices (102, 103, 104, 105 and 106), an input grid formation (107) consisting of a series of shapes for receiving an answer choice selection input or marking (107a); a tag line explaining the highlighted shapes (107 b); a progress indicator box containing question number/total number of questions (108), instructions for answering the question (109), a count down timer displayed either per question or total test duration (110), a progress timer displaying total time consumed (111), no. of correct answers indicator (112), no. of wrong answers indicator (113), metacognition awareness indicator (114); Users preferences setting area containing help button (115) settings button (116), swap button to enable swapping of displayed questions and answers (117), immediate feedback on/off button (118), exit button (119), personal notes (120), cursor or pointer (121); psychological status (122).

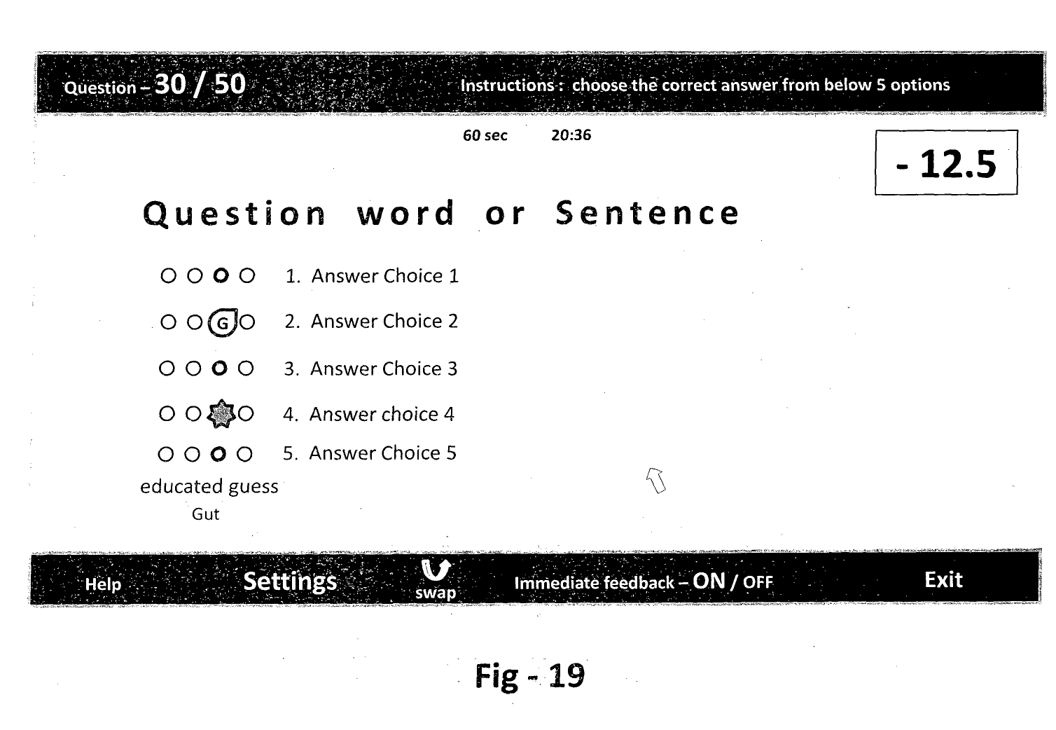

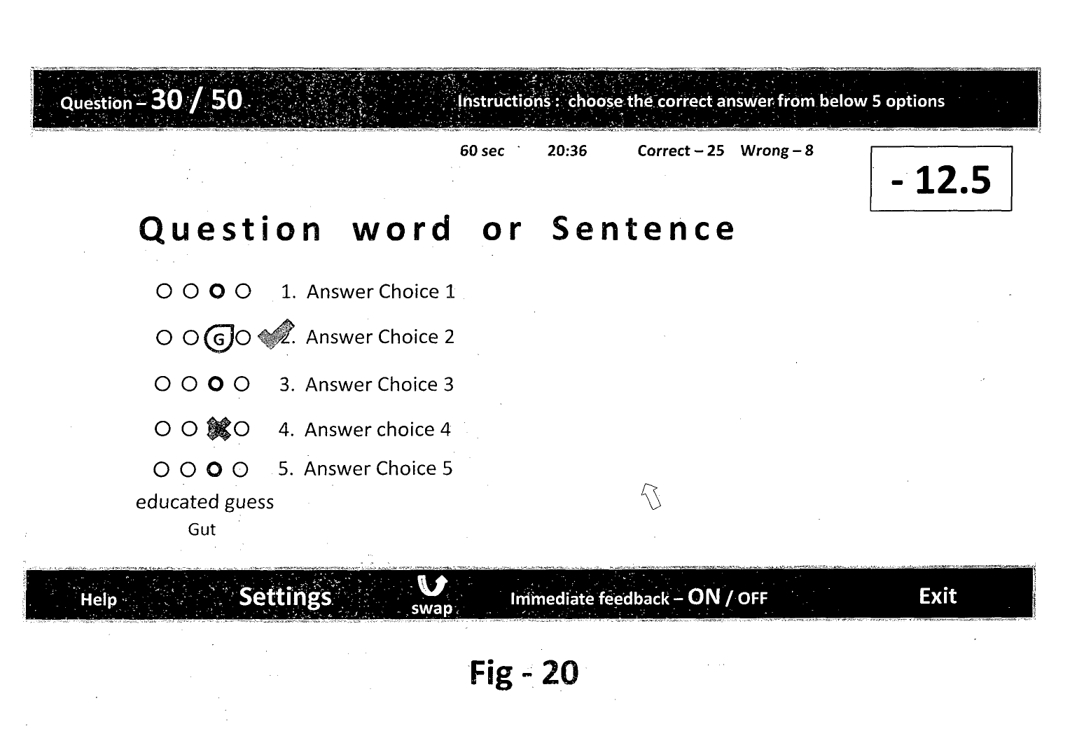

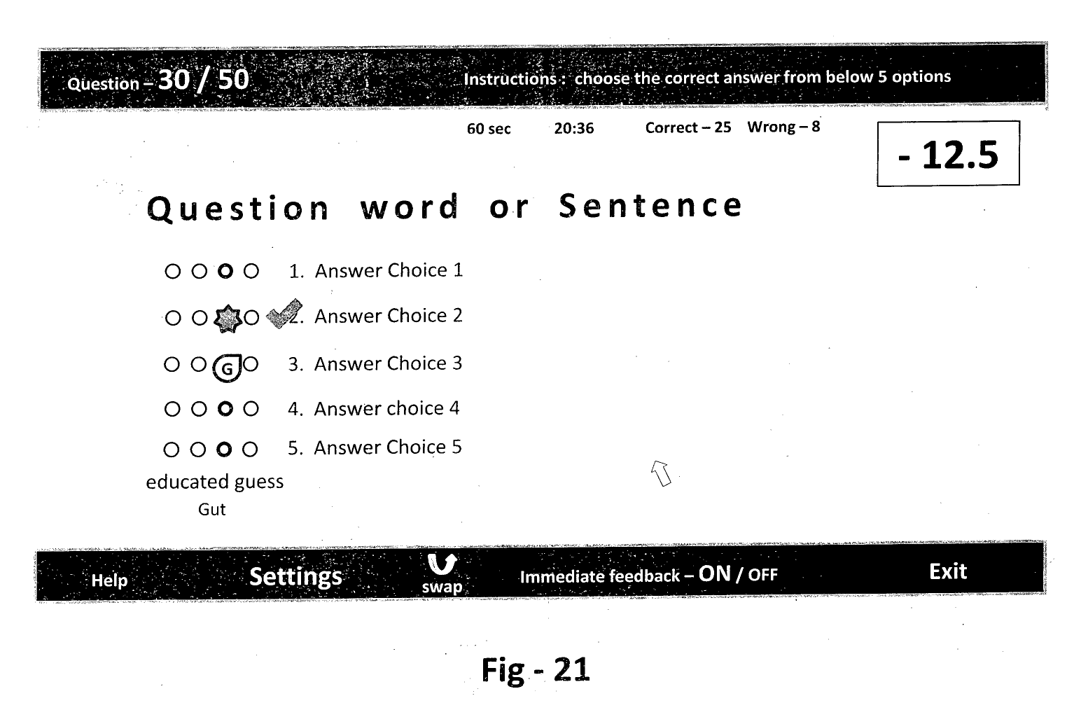

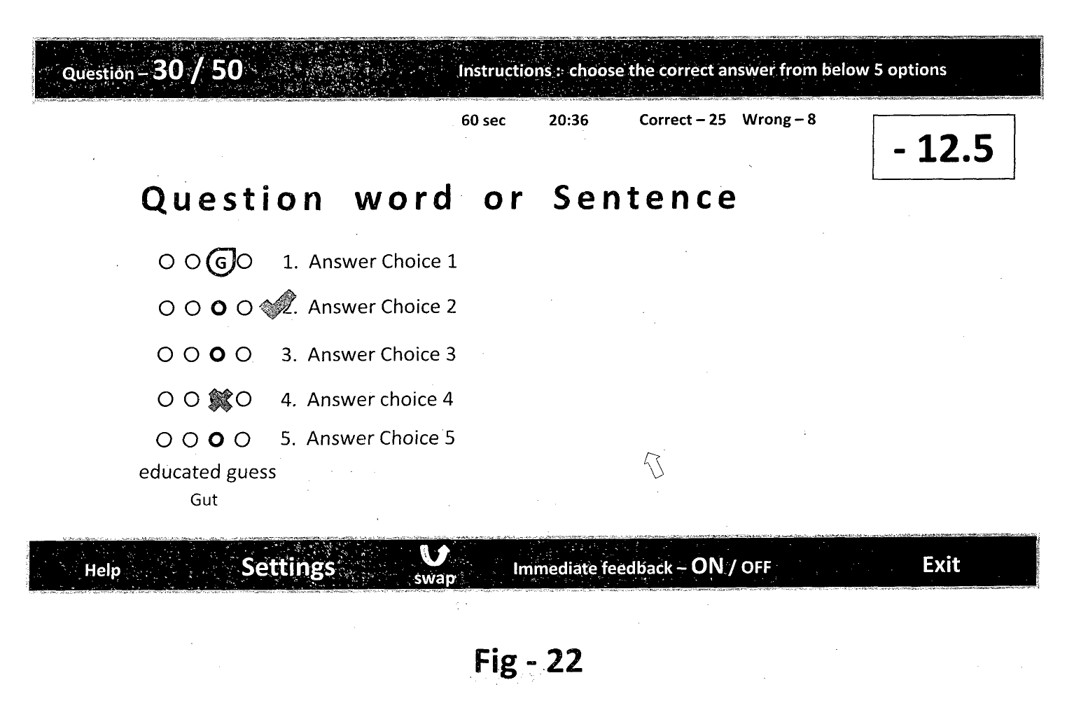

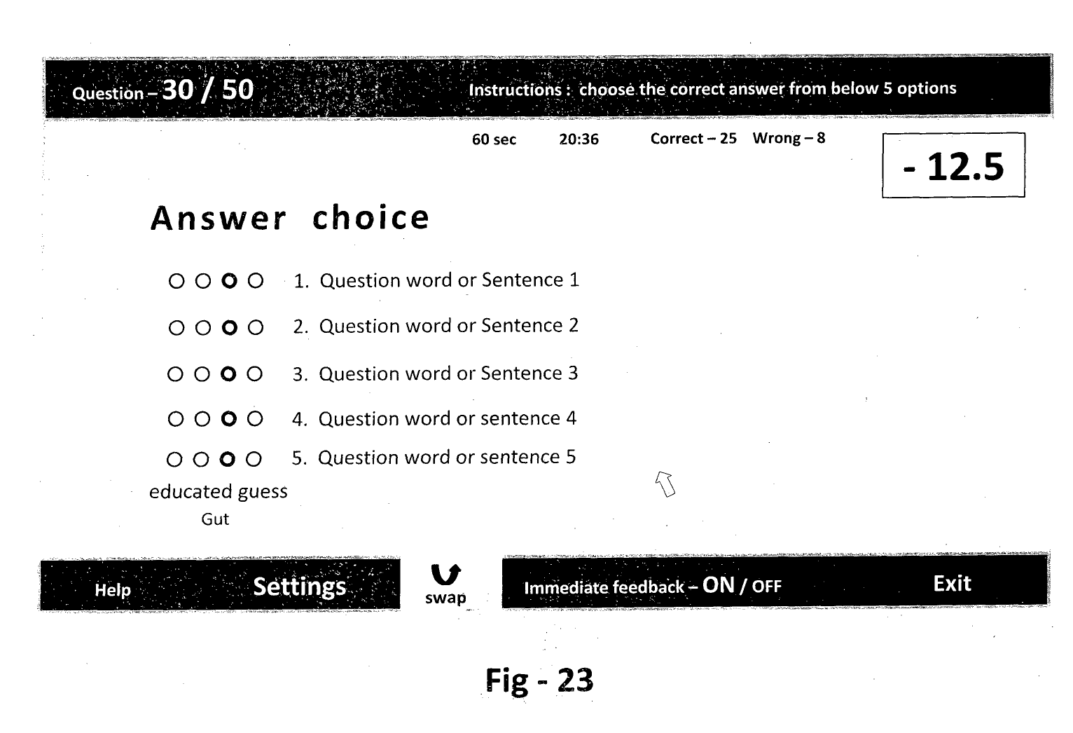

Explanation of exemplary embodiment of Using of the disclosed answer recording method by using the disclosed GUI by a user The user would read the question (101) and 5 answer choices (102, 103, 104, 105 and 106). Based on his knowledge, skill, aptitude, personal traits and metacognition, he arrives to an answer choice 105 for example, he would do one of the following to mark his answer, (note—the below description is made considering that the user is using a key board and a mouse as his input devices)—(1) If the user is familiar with the content in question or answers, and he has arrived to answer choice 4 (105) by genuinely solving it, and is confident about his answer choice 4 (105), he would click on B4-A1 (FIG. 1B). (2) If the user is not familiar about any one or more of information given in answer choices or questions, However he has arrived at answer choice 4 (105) by genuinely solving it and is confident about answer choice 4 (105) then he would press and hold the shift button to activate unfamiliarity value and then clicks on B4-A1 (FIG. 1B). (3) If the user is familiar with the content in question or answers, and has arrived to the answer choice as 105 by genuinely solving it and wants to revise more of such questions or review it later on, then he would click on B4-A2 (FIG. 1B). (4) If the user is Not familiar with the content in question or answers, and has arrived to the answer choice as 105 by genuinely solving it but is not very confident about his answer choice or wants to revise more of such questions, then He would press and hold the shift button to activate unfamiliarity parameter and clicks on B4-A2 (FIG. 1B). (5) If the user is familiar with the content in question or answers, and has arrived to the answer choice by guessing, then he would click on B4-A3 (FIG. 1B). (6) If the user is not familiar with the content in question or answers, and he has arrived to the answer choice as 105 by guessing, then He would press and hold the shift button to activate unfamiliarity parameter and click on B4-A3 (FIG. 1B). (7) If the user is familiar with the content in question or answers, and he has arrived to the answer choice 4 (105) by random selection, then he would click on B4-A4 (FIG. 1B), (8) If the user is Not familiar with the content in question or answers, and he has arrived to the answer choice 4 (105) by randomly then he would press and hold the shift button to activate unfamiliarity parameter and clicks on B4-A4. (9) When the user arrives to an answer choice 3 (104) either by genuinely solving it or by educated guessing, but his gut points to answer choice 4 (105), then he presses and holds the default CONTROL button to activate marking gut picking and first clicks on B4-A3 to mark his gut pick and then clicks on B3-A2 to mark his logical answer choice. A user can also indicate what is unfamiliar to him in the question. In one exemplary embodiment the user would mark ‘unfamiliarity in question type’ by pressing and holding down ‘shift’ key along with ‘q’ key. In order to mark ‘un familiarity in the content’ presented in the question one would be pressing and holding down ‘shift’ key along with ‘c’ key. Such a recording gives out very specific information. To ascertain the user that his answer input has been registered by the system, a visual feedback is given by turning the first pick (GUT) circle to a unique shape with letter G printed in it and the second picked circle turns to a grey star FIG. 19. A similar methodology is used for picking various answer types. This will occur simultaneously and would be more intuitively used by the user once he is familiar on how to input his answer choice. The dynamic animation of columns with respect to the cursor movement on them and also representation of taglines for corresponding highlighted columns makes the process even more assistive and intuitive. The help button (115) would give more information to a new user, to make him familiarize with the methodology.

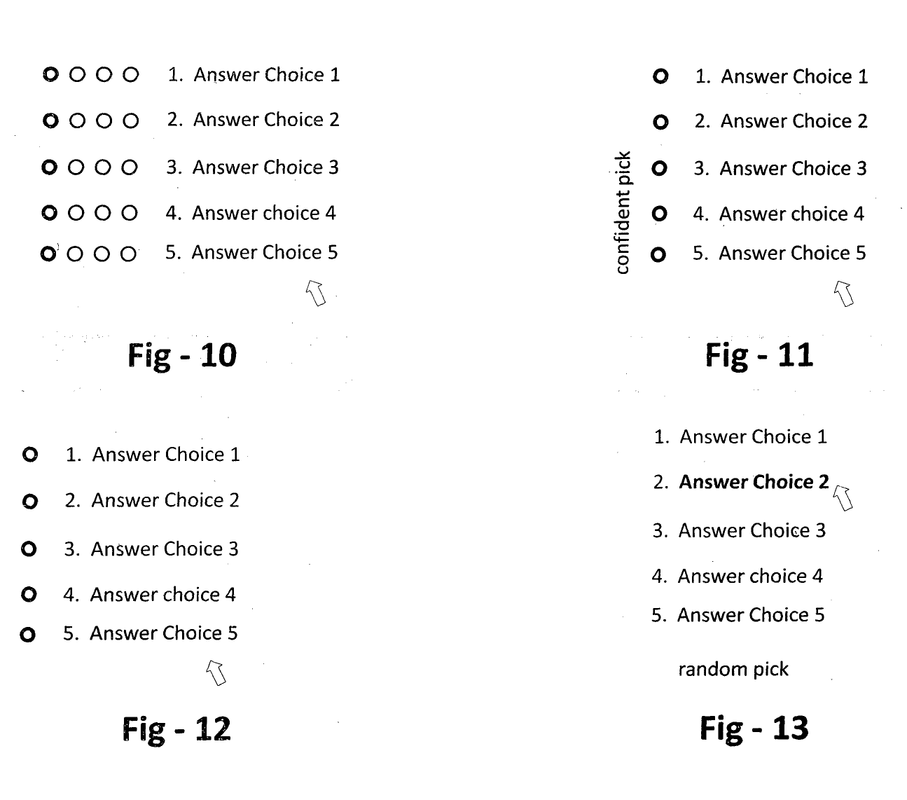

Explanation of an exemplary embodiment where customisation of the said answer recording method by a user is disclosed. Once familiar with the methodology, the user may find certain elements in the grid formation to be not necessarily visible in the GUI and hence might opt for a concise or more direct method. The user can customize the input grid formation by clicking on the settings button (116). FIG. 10, 11, 12, 13 shows some of the customised input grid formations. FIG. 10 shows a formation where the settings are, no. of columns is 4, display tag line is OFF. FIG. 11 shows a formation where the settings are, no. of columns in input grid formation is 1 and key buttons to activate confident pick column is by default, random pick is ‘a’ key on key board, educated pick is ‘s’ key on key board, random pick is ‘d’ key on the key board. Display tag line is ‘ON’ unfamiliarity and gut activations are set to default keys—SHIFT and CONTROL; FIG. 12 show a formation where the settings are similar to FIG. 11 except that the show tag line is set to ‘OFF’. FIG. 13 shows a formation where the user has pressed the ‘R’ key on the key board and has picked the second answer word as his choice. Settings for this formation are, no. of columns in input grid formation is 0 and key buttons to activate confident pick column is by default, revision required pick is ‘w’ key on key board, educated pick is ‘E’ key on key board, and random pick is ‘R’ key on the key board. Display tag line is ‘ON’ unfamiliarity and gut activations are set to default keys—SHIFT and CONTROL.

In one exemplary embodiment the user would indicate his psychological disposition status by hovering the cursor to enable a relevant icon represented on the interface (122) FIG. 1A. This is done by the user when he feels a change of temperament or general feeling during the course of the assessment. Similarly a variety of parameters can be enabled to the inputting elements be recorded with a single mouse click.

In one embodiment a user wants to track if his gut pick or logic pick is yielding more correct responses. For that the user would enable the function of recording logic pick after every gut pick. In such a scenario for every gut pick in the basic level, there are 3 possible outcomes. (1) Gut Pick Correct, Logic Pick Wrong, (2) Gut Pick Wrong, Logic Pick Correct, (3) Gut Pick Wrong, Logic Pick Wrong. By enabling extra parameters, as illustrated in the case of gut pick, more information can be recorded with single mouse click. For example a Delayed eureka moment, a moment in the exam where a student suddenly recollects the meaning of a word asked in previous question or formulae to be used in one of previous questions etc, can be recorded by pressing the ‘q’ key. In another example, A very important question can be recorded by pressing the ‘i’ key on the key board. Thus the input grid formation is highly customisable as per the needs of the user. However the information that is gathered is the same as that of the default input formation.

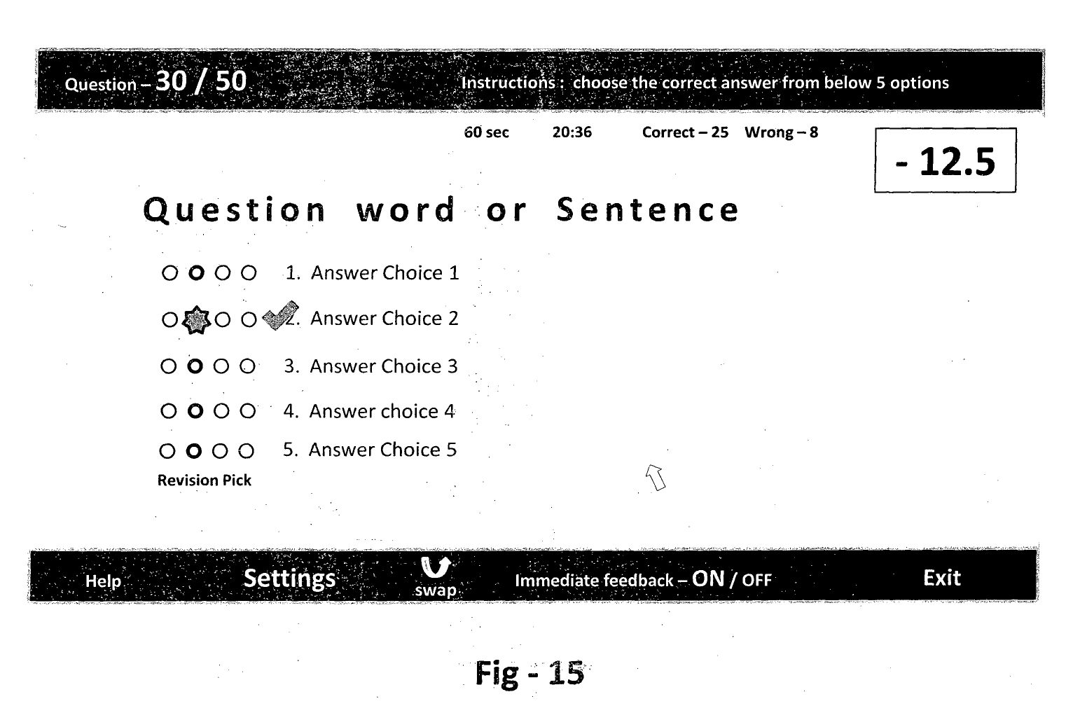

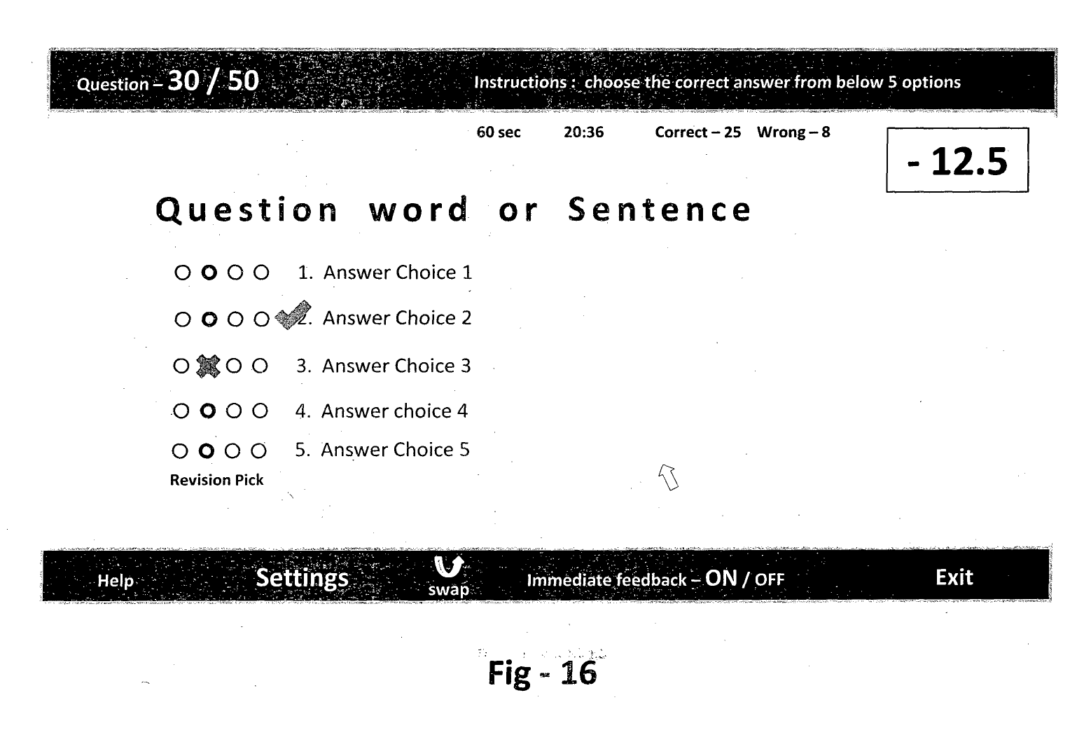

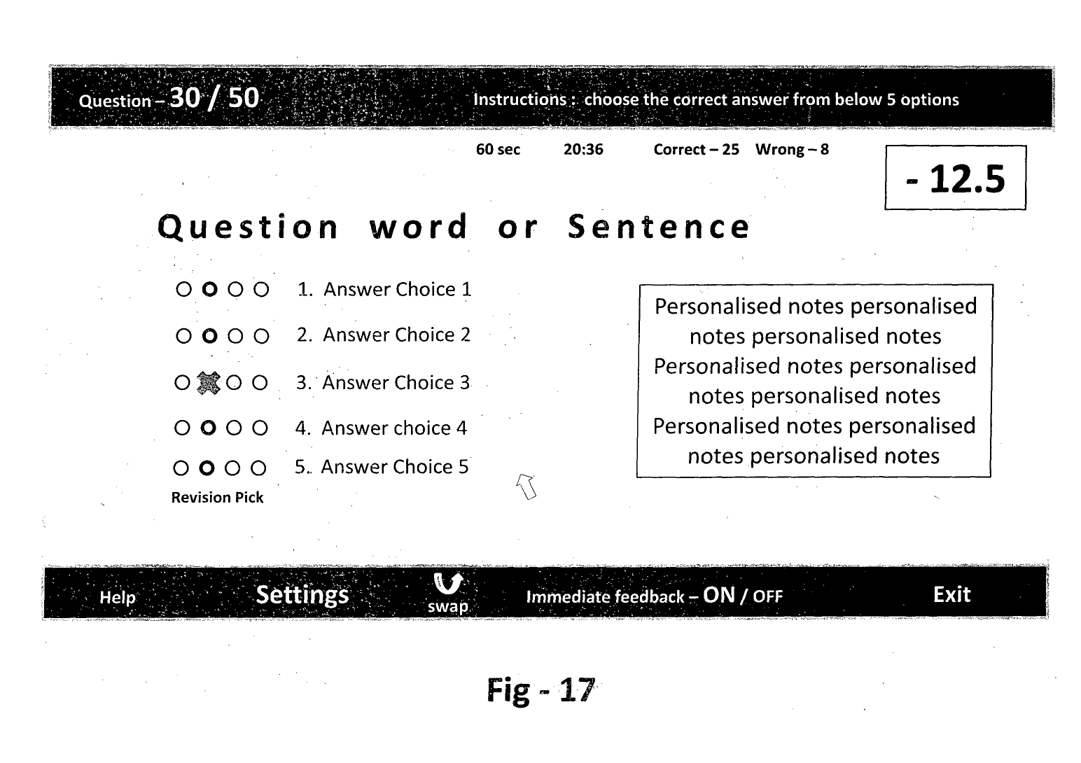

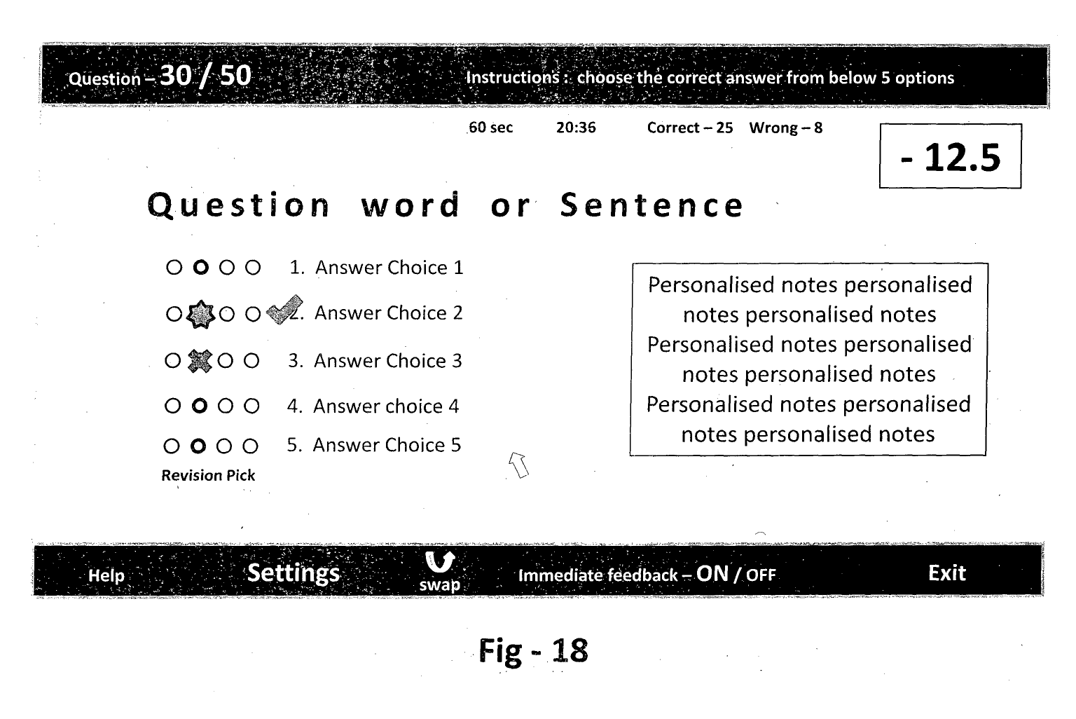

The output of answer inputting action can also cause a physical function as well. For example In one exemplary embodiment the single mouse click is encoded to cause a specific physical function of displaying feedback and next question after a delay of 3 seconds each, apart from marking an answer. In such a method whenever a user inputs his response by a single mouse click, the feedback is shown and after a delay of preset time and the next question is automatically displayed. In yet another embodiment by the single click of a mouse, every wrong answer is displayed along with a hint to evoke his thought process. The disclosed art incorporates many feedback methods based on the type and requirement of assessment that would help a student not only acquire new knowledge but also develop ones metacognition awareness. For example—No of Correct answers (112) and wrong answers (113)—gives instant information on how many questions one is getting right or wrong. Visual indication of correct answer choices shows what the correct answer is for the questions and helps the student ascertain his approach to solving a problem if the answer turns to be correct or help the student realise what the correct answer is if his answer choice is incorrect. This is achieved by turning the picked circle to a star if correct, subsequently showing a tick mark next to the correct answer choice FIG. 15 and to a cross if wrong, and subsequently showing a tick mark next to the correct answer choice. FIG. 16. When the immediate feedback mode is set to OFF, none of the above 4—no. of correct answers (112) and wrong answers (113), Meta cognition awareness indicator (114) and visual indication of correct and wrong answers are displayed in the GUI. Immediate feedback ON setting enables all the 4 of the above displayed dynamically. The user can choose what all feedback to be displayed on the test interface as per his ease of use or requirement.

As one can appreciate the fast recording of such a precise information very easily and effortlessly during the practice sessions/tests of exam itself as and when the user feels to record his thoughts, beliefs, needs and feelings, would enable a student to revisit them anytime to address his difficulties more promptly during review and remediation, error analysis or exam review, without having to put an effort to recollect the reasons, feelings, thoughts and needs that have arisen in the mind of the user while solving the said question & choosing the said answer choice in the said exam.

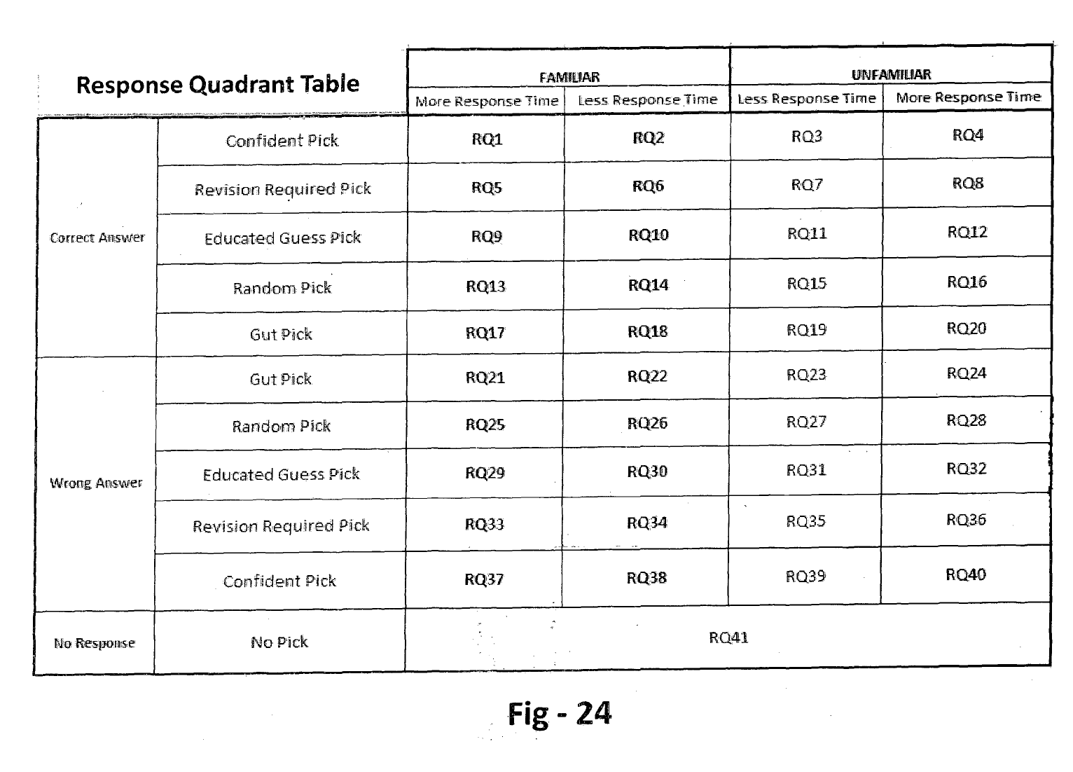

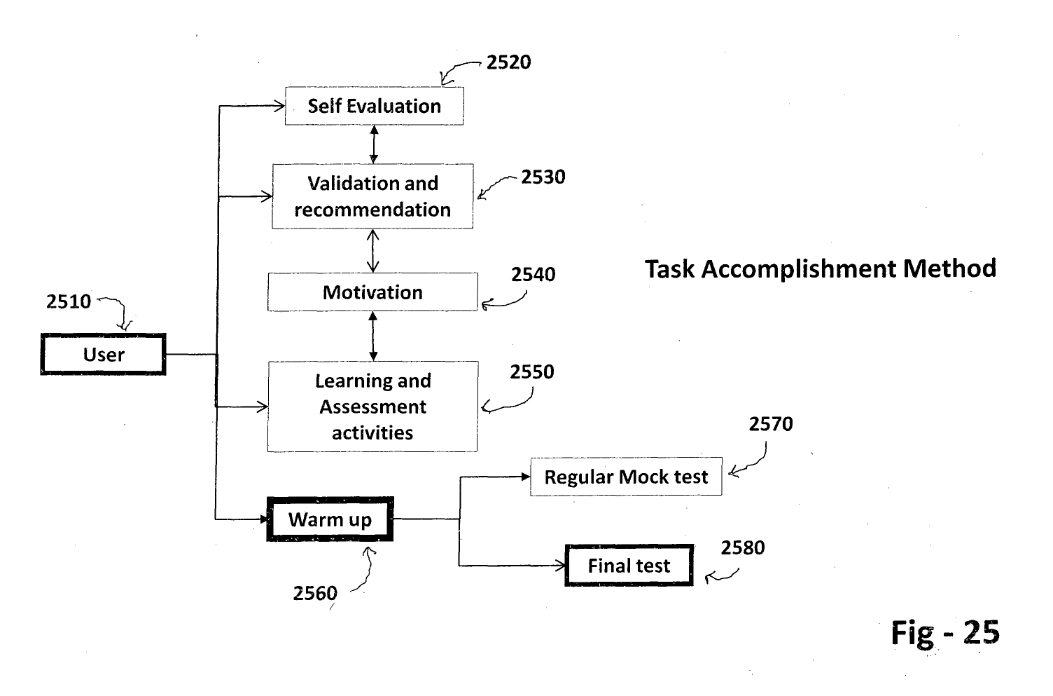

Valuable Data generated with disclosed answer choice recording method is disclosed—More than one up to 22023 unique outcomes are possible with the disclosed answer choice recording method using the disclosed GUI for each of the question displayed to the user and the user marking an answer choice by a single answer choice selection inputting action to log his answer for example a single click with a mouse as an inputting device. In one embodiment, some of the unique responses in its basic form are plotted in 41 response quadrants as shown in the FIG. 24. Each of these unique outcomes speaks about various personal traits, knowledge, ability, skill, aptitude, and metacognition of the student and helps the student and teacher to have deeper understanding of a student’ exam readiness and subject matter capability.

By use of the default answer input receiving element or input grid formation alone, one of the 10 possible varieties of insights against only 2 possible insights (that is either correct pick or wrong pick) as with conventional method of answering, can be recorded from a users' single mouse click action on an answer input receiving element, which are (1) Confident Pick Correct, (2) Confident Pick Wrong, (3) Revision Required Correct, (4) Revision Required Wrong, (5) Educated Guess Pick Correct, (6) Educated Guess Pick Wrong, (7) Random Pick Correct, (8) Random Pick Wrong, (9) Gut Pick Correct, (10) Gut Pick Wrong.

Similarly by encoding 2 parameters, familiarity and unfamiliarity, to the default parameters of answer input receiving element grid formation, 36 possible varieties of insights against only 2 possible insights as with conventional system of answering, can be achieved by the disclosed answer recording method, which are (1) Familiar; Confident Pick Correct, (2) Familiar; Confident Pick Wrong, (3) Unfamiliar; Confident Pick Correct, (4) Unfamiliar; Confident Pick Wrong, (5) Familiar; Revision Required Correct, (6) Familiar; Revision Required Wrong, (7) Unfamiliar; Revision Required Correct, (8) Unfamiliar; Revision Required Wrong, (9) Familiar; Educated Guess Pick Correct, (10) Familiar; Educated Guess Pick Wrong, (11) Unfamiliar; Educated Guess Pick Correct, (12) Unfamiliar; Educated Guess Pick Wrong, (13) Familiar; Random Pick Correct, (14) Familiar; Random Pick Wrong, (15) Unfamiliar; Random Pick Correct, (16) Unfamiliar; Random Pick Wrong, (17) Familiar; Gut Pick Correct, (18) Familiar; Gut Pick Wrong, (19) Unfamiliar; Gut Pick Correct, (20) Unfamiliar; Gut Pick Wrong, and more specific unfamiliarity responses including (21) Unfamiliar content; Confident Pick Correct, (22) Unfamiliar content; Confident Pick Wrong, (23) Unfamiliar question type; Confident Pick Correct, (24) Unfamiliar question type; Confident Pick Wrong, (25) Unfamiliar content; Revision Required Pick Correct, (26) Unfamiliar content; Revision Required Pick Wrong, (27) Unfamiliar question type; Revision Required Pick Correct, (28) Unfamiliar question type; Revision Required Pick Wrong, (29) Unfamiliar question type; Educated Guess Pick Correct, (30) Unfamiliar question type; Educated Guess Pick Wrong, (31) Unfamiliar content; Educated Guess Pick Correct, (32) Unfamiliar content; Educated Guess Pick Wrong, (33) Unfamiliar question type; Random Pick Correct, (34) Unfamiliar question type; Random Pick Wrong, (35) Unfamiliar content; Random Pick Correct, (36) Unfamiliar content; Random Pick Wrong.

A student might face friction at one or more steps of problem solving, that he might feel to record, this can be categorised into difficulty at various steps for example, Friction at step 1 indicates that the student is having problem reading and understanding the question. Friction at step 2 indicates that the student is having problem in deciding a strategy to solve it. Friction at Step 3 indicates that the student is having problem in applying a strategy. Friction at step 4 indicates that the student is having problem at deriving an answer and reassuring one has the right answer. Friction at step 5 indicates the student is having problem picking the answer choice from the available options.

By encoding the ‘problem solving Step level friction’ Parameter, to The above said parameters encoding, 5508 possible varieties of insights against only 2 possible insights as with conventional system of answering, can be achieved by the disclosed answer recording method, For example on of such insights can be Familiar; Revision Required Wrong with friction at step 1 or Familiar; Revision Required Wrong with friction at step 2 and 5 or Familiar; Revision Required Wrong with friction at step 3,1,5 or Familiar; Revision Required Wrong with friction at step 4 or Familiar; Revision Required Wrong with friction at step 4, 5.

By encoding the response time Parameter, to the above said parameters encoding, 11016+ possible varieties of insights against only 4 possible insights (correct answer with less response time, correct answer with more response time, wrong answer with less response time and wrong answer with more response time) as with conventional system of answering, can be achieved by the disclosed answer recording method. For example one of such possible outcome can be Familiar; Revision Required Wrong with friction at step 5 and response time more than best performance/student average response time.

By encoding the users' overall comfort and composure, to the above said parameters encoding, 22023+ possible varieties of insights against 4 possible insights (correct answer with less response time, correct answer with more response time, wrong answer with less response time and wrong answer with more response time) as with conventional system of answering, can be achieved by the disclosed answer recording method. For example Familiar; Confident Pick Wrong with friction at step 5 and response time less than best performance/student average response time; under extreme pressure. As it has been illustrated, one can appreciate the depth and breadth of insights a student can record in the disclosed answer recording method.

Data Analysis: Even though there are more than one input receiving element per answer choice, total number of correct and wrong answer choices in any conducted test can be collected very easily. For example Total no. of correct answers are derived by a consolidate count of all correct answer picks in a session, irrespective of response type & parameters and Total no. of wrong answers by a consolidate count of all wrong answer picks in a session, irrespective of response type and Parameters. Accuracy of assessment metrics is one of the advantageous results of the said answer recording method. For example Ones Mastery in solving a question, referring to the awareness and possession of Knowledge about content of the question & the best means of solving it, the successful application of such awareness and possession of knowledge to solve a given question and doing so in a record time and choose the appropriate answer; can be more accurately be measured with data collected by the said answer recording method. For example if a users' recorded answer choice is ‘familiar, confident pick, correct, with less response time, under extreme pressure’, by assigning appropriate values to each of the parameters like for example—Familiar (value: 1); confident pick (value: 1); correct (value: 1); less response time (value: 1); under extreme pressure (value: 1), the mastery level can be derived as (1+1+1+1+1)/5=1 on a scale of 1 for the content in question. For a response type of Familiar (value: 1); revision required pick (value:0.75) correct (value:1) and more response time (value: 0.5) under extreme pressure (value: 1) has a mastery level of [(1+0.75+1+0.5+1)/5] 0.85 on a scale of 1. It can be appreciated that with the help of disclosed method one can easily differentiate the mastery level for 2 correct responses, by simply assigning standard values to various parameters recorded in the said answer responses. The one more of the many other advantages is that some metrics which cannot be obtained by the current assessment methods available in the market for a student or tutor are achieved by the disclosed answer recording method easily and quickly, for example personal traits like but not limited to educated guess ability, gut factor and luck factor, where in Educated guess ability indicates ability of a student to use answer elimination strategy to derive at an answer choice. In one exemplary embodiment it is calculated as the total number of educated guess picks correct/total number of educated guess picks, the value presented on a scale of 100. Gut factor indicates the percentage of intuition picks becoming correct. The higher the value, the better the gut factor and a student is highly recommended to trust his gut. The lower the gut factor, a student is highly recommended to go by his logic choice. Luck factor—indicates how lucky a student is in picking a random correct answer and what is his lucky choice option or a random pick strategy that works best for him. With the ability to measure the personal traits, one can also determine if a person is able to perform well in a test without having to gain mastery in the subject matter tested in an exam. This can be achieved by monitoring and analysing how a user is faring a test by using the said users' correctness of educated guess ability, gut factor and luck factor as against correctness of confident and revision required answer picks. Unlike the other methods available in the market for the user or the tutor where a multitude of assumptions are made in determining the meaning of a response and gauging a users' task relevant subject matter comprising his existing Knowledge or Ability or Skill or Aptitude or personal traits or Metacognition awareness or metacognition regulation, in the disclosed method, valuable analysis is conducted making use of the explicit data directly inputted by the user consisting detailed insights given out by the student, and displayed back to the user and mentor in a very easy to understand way by means of indicators. Based on the accurate analysis achieved from the data recorded by the disclosed answer recording method and combining the data with question and test information, the said subject matter can be segregated into various categories and displayed them back to the user.

Usage of the aforementioned GUI having the disclosed answer recording method for conducting different types of assessments is further disclosed. Depending on the type and purpose of the assessment some of the features and indicators of the said default GUI represented in FIG. 1A are either disabled or enabled to support the purpose of assessment. For example in one embodiment GUI with disclosed answer recording method for conducting a Mock test is customised to suit the purpose of mock test, a diagnostic assessment having the purpose of 1. To Assess the users ability to perform in the test. 2. Make the user aware of the knowledge, ability and skill gap, awareness on personal traits and metacognition for further learning. Hence some functions and indicators of the default GUI like immediate right or wrong answer feedback, progress indicators like no. of correct or wrong answers, MC indicator, swap function, access to quick hands on learning, are disabled. And the use of response types and various parameters would be remained active so that the user can record his means of arriving an answer selection, reasons, feelings, thoughts and needs that have arisen in the mind of the user while solving the said question & choosing the said answer choice effortlessly with a single mouse click. One can appreciate that such recording during the mock test would help the user to Validate his expectation match and also will enable user to conduct detailed review and further learning easily after the test, without having to the effort to recollect each one of the reasons, feelings, thoughts and needs that have arisen in the mind of the user while solving the said question & choosing the said answer choice, as these information has already been recorded at the time of their occurrence. One can also appreciate that such recording during the test would not interfere with the users attention to answer a question within allotted time per question and no additional time is required for recording the same. In such an assessment type the cognitive and metacognitive learning happens outside of the test environment, when the student conducts error analysis and probe into the recorded reasons, feelings, thoughts and needs that have arisen in the mind of the user while solving the said question & choosing the said answer choice. For example in one embodiment the collective data comprising of comprehensive parameters is utilized in analyzing and showing to the user his metacognition perception, before, during and after the test. This comparison helps the student realize the mismatch of feelings and beliefs, shaping his correct metacognition awareness. Such disclosed GUI mode can be used for evaluation tests, standardised tests, summative and formative tests and would prove very helpful for students and teachers.

In one embodiment, a diagnostic assessment where the user wants to conduct for the sole purpose of segregation of vast amount of data, for example, assessing a GRE wordlist consisting of 5000 words, the user is presented with ‘a GUI having the ability to enable such segregation process very swiftly and the same time develop awareness of ones knowledge of words, the process called in here as scout mode, consists of all functions and features enabled except the ‘quick hands on learning’ and personal notes. Hence the Metacogniton indicators indicates mismatch of beliefs instantly, the immediate feedback shows the correct answer and wrong answers. The total number of Correct and wrong answers quantifies the objective, performance. In such an assessment mode a student is exposed to a partial cognitive and metacognitive awareness within the test environment.

In one embodiment, a diagnostic assessment where the user wants to learn new information, unlearn-relearn old information, or memorise mammoth information for example mastering GRE wordlists, the user is presented with ‘a GUI’ having the ability to enable such Learning activity consisting of all functions and features enabled. In such an assessment mode a student is exposed to full cognitive and metacognitive awareness within the test environment. This mode can be used for efficient learning and top performance in exams in shortest time or a review test for the purpose of measuring the progress of learning, identifying the areas for further learning and top performance in an exam, and reinforcement of learnt knowledge, Ability and Skill, Which is often conducted after a learning session. Or a Practice Test for the purpose of practicing already learnt information to gain mastery over it.

As explained the GUI with the disclosed answer recording method can seamlessly replace and suit any assessment session requirement, hence has the wider applicability to assist various assessment requirements. A typical e-assessment method using the disclosed GUI and answer recording method consists of 1. Presenting a question to the user with an interface as in FIG. 1A. 2. receiving an answer choice by the said user comprising the disclosed answer recording method 3. decoding of the response input by the said computer and storing it in the said database. 4. Generating and displaying the indicators and analysis to the said user and tutor.

The test and question content for such assessments can be generated in number of ways. In one embodiment depending on the users assessment needs, the assessment generator consisting a set of algorithms, would access various subject matter databases, including those of other participating e-testing and e-assessment platforms and generates a test to be administered to the user utilising the disclosed GUI and answer recording method. The data collected from such a test is stored in individual user databases and makes it available for participating e-testing and assessment platforms for respective analysis and representation of analytics to the user to foster his Metacognition.

To develop metacognition of students at macro level and simplify the task accomplishment process a computer implemented system to support users' learning for a task performance using the said answer recording method and assessment GUI is disclosed—comprising a means for setting up a task conducting self evaluation, where in a task comprises use or performance of at least one of the user's task relevant subject matter comprising his existing Knowledge or Ability or Skill or Aptitude or personal traits or Metacognition awareness or metacognition regulation, a self evaluation (2520) comprising of one or more of (i) the said users' own capability, (ii) state of preparedness to accomplish the task, (iii) user's perception on how and when a task is conducted, (iv) user's perceived likelihood of accomplishing success, (v) user's perception on different means of learning and performing activities available for accomplishing the task, a means for verification by the software of statistical analysis embedded in the computer of the validity of the users' task self evaluation and displaying the ground reality in the form of statistically analysed indices, identifying possible ways of improvement in terms of improvement in mastery over the subject matter or prospects of success in reliance on alternative personal traits of the user including educated guess ability, gut factor and luck factor (2530), a means for displaying projections prepared by the computer on various prospects or opportunities the said accomplishment of the said task would provide to the said user as a means to motivate the said user to accomplish the said task successfully (2540), a means for enabling the said user in conducting and repeating the self evaluation, testing his preparedness by undertaking an e-assessment of claim 1 to improve upon the relevant shortcomings and weakness (2550), a means for equipping the said user with validated and quantified assessment of his preparedness (2560) for performing the said task in an examination (2570) or a performance of his knowledge in real life (2580).

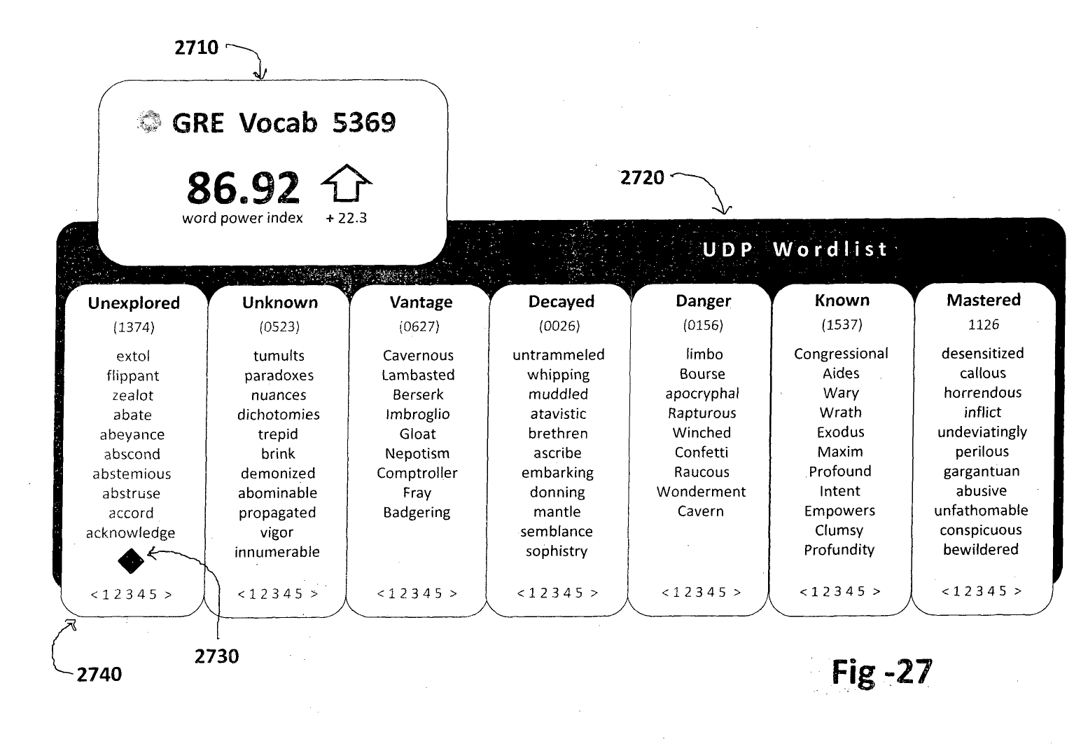

In one embodiment by use of disclosed system task accomplishment is achieved through a user performing various task related tasks with help of crucial indicators indicating task accomplishment success and simultaneous grouping of subject matter into various categories based on users' personal traits and mastery of a subject matter, and providing a variety of learning and assessment applications either inbuilt or of third party, based on the users' mastery and performance orientation is disclosed FIG. 27. The disclosed system transforms the complex learning activity into a simplified comprehendible visual organisation that can be explored by the user to get more insights about his chosen task and use his metacognition to perform task related activities and validate his beliefs easily at every stage of learning or assessment activities performed for task accomplishment. The disclosed system enables a student to follow his natural course of learning; meaning learning by use of one's metacognition awareness and metacognition regulation, by enhanced Metacognition achieved through Metacognition validation. Users Can achieve a task accomplishment with less effort and time, can build realistic confidence on task accomplishment, can access various learning and assessment material available on internet, can explore various exams the user is ready to give with said users' current subject matter mastery or personal traits that shall open up more career opportunities etc.

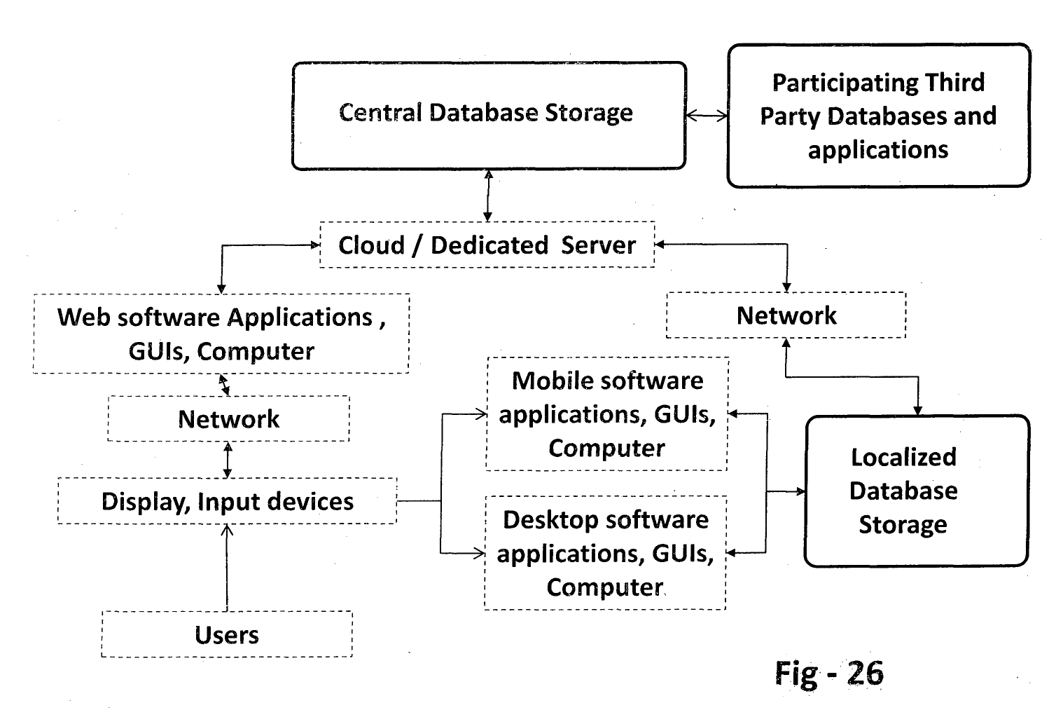

Such a computer enabled system includes necessary components, like but not limited to Plurality of input devices, storage devices, network system and enablers, plurality of graphic user interfaces, centralised and localised databases, algorithms, Indicators, metrics generators, assessment generator, assessment simulator, strategy generator, Metacognition monitor, activity monitor, 3^{rd} party learning applications, online e-learning materials, etc the said System consisting of plurality of programmed applications would store information about the user's activity and his personal preferences in both local and centralised databases FIG. 26. The applications can be used by the user from plurality of devices. When the application is unable to connect to the centralised database, it shall first store the information in localised database and then transfers relevant information to the centralised database, when ever network is connected. Thus the user can use the application irrespective of whether he is connected to a network (online) or not (offline). The centralised storage database would be hosted on a cloud or dedicated server which consists of storage for various application databases that would store various information related to Users activity, preferences, subject matter, question banks, mock tests, etc.

In one exemplary embodiment a task accomplishment GUI consists of a task readiness Indicator indicating how well a user is prepared for the exam is derived based on Subject matter thoroughness of various subjects tested in a task, an interactive visual database or a visually represented groups of data and a strategy prompt suggesting what is the recommended users' next best action. With the help of these 3 tools the user shall decide ones next course of action. This configuration becomes the base-camp for ones task accomplishment and becomes an anchor point for a user to always be in focus of achieving his task, and increase his task related subject matter by further exploring and interacting with these 3 elements.

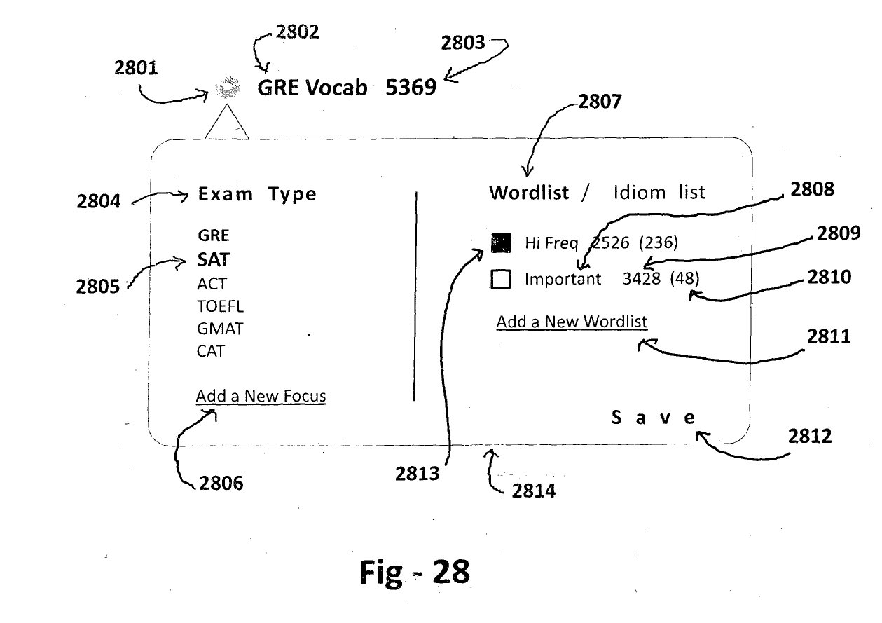

In one embodiment the visual configuration of these 3 elements is represented as in FIG. 27 for a user who has set his task as vocabulary learning for GRE exam consisting of task information with indicator (2710), interactive visual database, called here in as Unique Dynamic Personalised (UDP) wordlists (2720). And a strategy prompt (2730) on one of the groups of data column (2740). A typical user of such system would first login to the system and creates an account. He would then set up his task. For example, in this embodiment a users' task is to learn GRE vocabulary consisting of 5369 words in 30 days of time. FIG. 28 represents one of such embodiments in one of its simplest format containing selecting of the exam type and knowledge elements, i.e. words. The user would click on the settings button 2801, seen just before the default exam name 2802 and numerical 2803. The numerical displayed 2803 indicates the total number of unique words that he needs to master for the chosen exam 2802 and the wordlists that are active with in it. ‘Total Unique words’ is an indicator of exclusive individual words available in all wordlists that are selected. Sometimes, there may be some common words repeated in one or more wordlists, so if there are any common words in selected 2 or more wordlists, the repeated word will be counted as only one unique word. This minimizes duplication of information to be learnt and gives the student an accurate indication of words to be learnt. The opened applet 2814 consists of a list of various exam types 2805 under the heading Exam Type 2804 on the left hand side and a List of wordlists or idiom lists 2807 on the right hand side. The user would first select the exam focus of his choice. The selected exam focus would become bold indicating its selection status. The wordlist column in the interactive visual database would automatically show an updated relevant List pertaining to the selected exam. Each relevant List 2808 is followed by a numerical value without brackets 2809 representing the Total Unique words available in the wordlist and a numerical value within brackets 2810 representing the pending words the user will have to attempt learning. This method of information quantification helps student perceive and comprehend the task in a single glance. The student would then pick the wordlists he would like to study and then saves the settings by clicking on SAVE 2812. The chosen exam type and the total Unique words in the selected wordlists are indicated in the heading of the setting button, at 2802 and 2803. That information becomes his scope for further study. The saving of task settings would dynamically update the ‘interactive visual database’. In the exemplary embodiment ‘interactive visual database’ FIG. 27 consists of a collection of word groups segregated based on knowledge, Ability Skill, Personal traits and, metacognition level obtained from the disclosed answer recording method. In one embodiment this collection is named as UDP wordlists, meaning Unique, Dynamic Personalised wordlists consisting of; Danger Content group, a collection of words from the test for which the user has an answer outcome of confident pick wrong and revision required pick wrong, irrespective of variety of other parameters. This segregation signifies misconstrued information one posses and the incorrect metacognitive knowledge about his mastery of a subject. The user will need to immediately unlearn and relearn these words as soon as possible, as carrying along this misconstrued information can depreciate or harm the users' probable score. Decayed Content group, a collection of words from the test for which the user has an answer outcome with forgotten parameter. This indicates that the user once had known this information well and now requires some practice to bring back to either performance or mastery level. The user will need to practice answering more of such questions to take maximum advantage of the already known information to score high marks. Mastered Content group—a collection of words from the test for which the user has an answer pick of confident pick correct with less response time and no friction recorded. Indicates that the user had mastered this information well and further learning is not required. Only occasional review during the mock tests is enough. Known Content group—a collection of words from the test for which the user has an answer pick of confident pick correct with more response time or revision required correct with more or less response time and some or no friction recorded. Indicates that the user requires further practice, however can take the test without more practice as well. Only occasional review during the mock tests is enough unless the user wanted to practice further. Unknown Content group—a collection of words from the test for which the user has an answer pick that has ‘Unfamiliar’ parameter enabled and the answer pick is incorrect. A student will have to study them to become aware or learn the content, based on extent of information to be learned in order to achieve minimum required performance is achieved. Vantage content group a collection of words from the test for which the user has an answer pick that has ‘Unfamiliar’ parameter enabled and the answer pick is correct. A student will have to study them to become aware or learn the content, based on extent of information to be learned in order to achieve minimum required mastery. A typical grouping is illustrated in FIG. 27. This grouping is just an illustration and not a limitation of the segregation based on recorded data. In one embodiment further segregation is done where in consistently shown mastery of the users' subject matter is grouped under aced category. One skilled in the related art can appreciate that this segregation of information is directly available from users explicit inputs and is accurate without the need of complex algorithms and effortful question and answer drafting, which quite often are based on assumptions trying to capture a users strengths and weakness. As with the disclosed task accomplishment system and answer recording method, the users' validation of beliefs and metacognition occur the moment they glance at the elements in the groups of data on the basis of how they have been organised, the user start developing realistic confidence on ones task accomplishment readiness. The words within the each one of the groups can be organised in various sequences, depending on the priority of a users learning needs. This can be determined by the user himself or by an external impetus like a tutor or algorithm. This kind of visual segregation enables a user to use one metacogniton regulation in deciding on a strategy balancing one mastery and performance orientations. For example if the collective words in unexplored, vantage and decayed are more than that of known group, then the user having a tendency to mastery of words, would realise the need of attending to the words that are not yet learnt, rather than spending more time on already known words and mastering them. In absence of the disclosed system a user due to lack of awareness would fall prey to ones mastery orientation and unnecessarily wastes his time. For a user who has performance orientation, would be trying to learn as many as possible without having bothered to bring his understanding to a required level. In such case the visual database will create awareness if his method of learning is appropriate or not. In one embodiment a suggested ratio between ones mastery and performance orientation is displayed further enhancing the users awareness in knowing if his approach is correct or not. In response to the displayed ratio, the user would either accept it or set his own preference and conducts further activities generated by the system for the set ratio. Hence by use of the disclosed system coupled with disclosed answer recording method, a user would benefit tremendously in accomplishing ones task. Based on ones validated awareness and correct orientation the user by Means of the disclosed system can conduct a variety of task accomplishment activities.

Instant awareness facilitation or learning: For example, the user can click on any of the word to open up a ‘quick hands on learning’ GUI. With this interface the user would know quick meaning of the word instantly thus the effort of searching of word meaning separately has been minimised and the ease of looking up a word has been improved. Also the user can browse through user generated content of hints created pertaining to a word, search news to learn the word in context and image archives to develop a visual impression of the word or he can create or upload his own hints in the form of images, videos or text using this GUI. Once done with his quick learning, the user can close the pop window by click on the close button and resume his main learning session

Similarly. by using ‘quick hands on learning’ tool the user can instantly build subject matter awareness on a symbol or numerical or character or shape or word or a diagram or a picture, or a group of symbols/numerical/character/shape/word/diagram/picture that appears on any of the GUI's connected, to the said task awareness accomplishment system. This is achieved by encoding the said element with a machine readable coding that will pop up the window on the onset of receiving an input marking on it. The steps comprise: (1) displaying of Pop up window on the onset of the said user clicking on a symbol or numerical or character or shape or word or a diagram or a picture, or a group of symbols/numerical/character/shape/word/picture/diagram, carrying a machine readable encoding, appearing anywhere within the plurality of GUIs connected to the said network system from the said user, (2) Displaying pertinent information related to the selected symbol or numerical or character or shape or word or a diagram or a picture, or a group of symbols/numerical/character/shape/word/picture/diagram in the pop up window, (3) receiving and recording custom content created or uploaded by the said user related to the said symbol or numerical or character word or shape or a group of symbols, numerical character, word, carrying a machine readable encoding, (4) aving the new information in the said users' database; (5) retrieving and displaying the recorded information to the said user in future on the said user's explicit request.

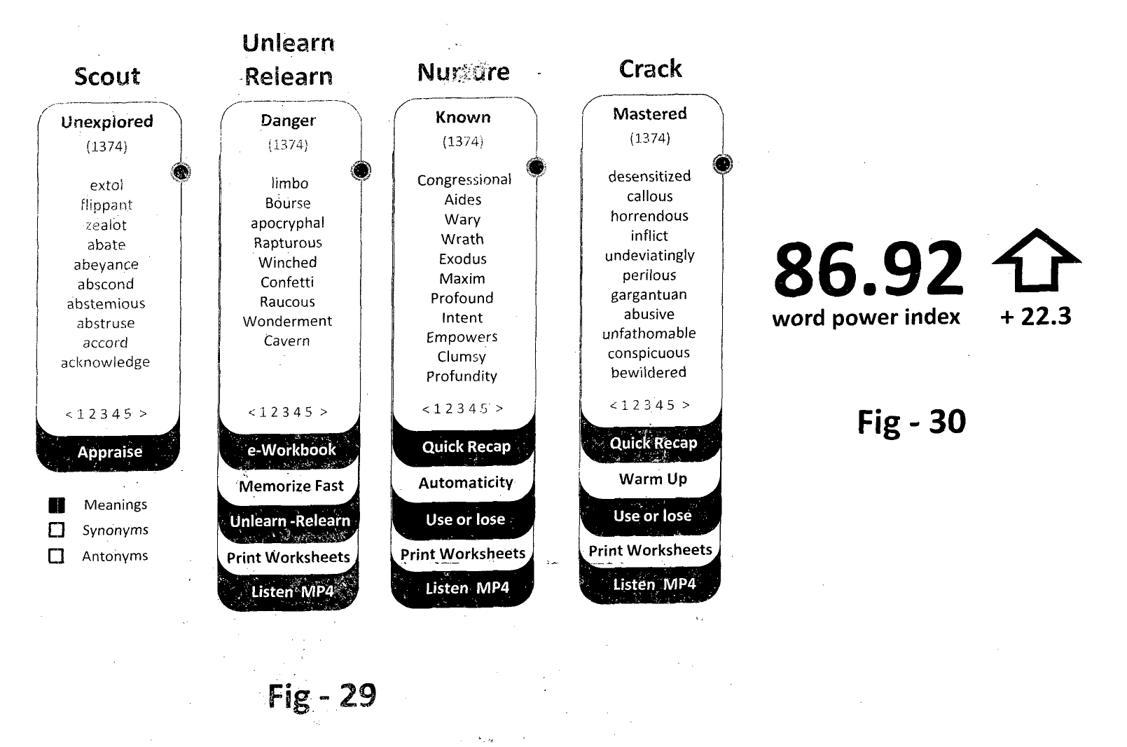

Group level learning and assessment: A user can also conduct group level activities by hovering the mouse on the individual columns and activating displaying of different associated activities related to respective columns FIG. 29. By clicking on any one of displayed activities the user can perform that activity for the words containing in the selected column. With the assistance of strategy prompt (2730), in this case a diamond shape, displayed on one of the group columns, the user would become aware on what can be an ideal next activity for him. The numbers displayed within the brackets, appearing below the column name, indicate the total unique words available within each of the columns that are pending for a task by the user. When a user first starts using the UDP wordlists, the Unexplored column would be filled in with the words pending scout or appraisal. A user can conduct scout, by hovering the cursor on the unexplored group, a link of assessment activity appears and by clicking on it the user can launch the assessment GUI. After the assessment activity various groups would be filled with words depending on the information recorded by the user by using the disclosed answer recording method. The UDP word list is accompanied with a dynamically changing word power index indicator FIG. 30 which indicates the acquired word power of the user for the selected exam focus. It will give necessary impetus to the user by suggesting if his word power is improving, static or worsening compared to the last study session or activity. Each of the individual groups are tagged with various activities that the said user can perform. A typical student who wants to learn new words for example has many options available for him. For example A user can conduct ‘memorize fast/Perfect Practice session. This can be activated by hovering the mouse on the ‘unknown content group’ column, that would pop up many activities in which memorise fast activity is one of them. The user then can select the memorise fast activity by a mouse click and the application will initiate a learning session. in one embodiment the session may consist of a test GUI as in FIG. 1. In one of the embodiments the user can choose an activity ‘e-work book’ where in he would be first presented a GUI to conduct the said activity.

In one exemplary embodiment the disclosed system may consist of a means for facilitating the said user conduct the said task related offline activities or online activities through a networked computer system, comprising: displaying a task accomplishment GUI containing visually represented groups of data containing the task and its user's pertinent subject matter with indicators, task related information, associated inbuilt and third party activities applications; receiving various task and activity pertinent inputs either from the said user or from the said user's tutor or an algorithm, updating the visually represented groups of data dynamically; receiving an input from the user as a selection on one of the displayed activities of a group of data; launching the selected activity enabling the user to perform the activity with related groups' subject matter; monitoring the user activity; updating the users' groups of data based on the outcomes of his activity; indicating a visual prompt, generated by a algorithm considering the said users' said mastery and performance ratio, on one of the groups of data attracting users' attention for the next proposed task based activity.

Task level activities: Developing task awareness by the user by interacting with the Task Accomplishment GUI is assisted by 1. receiving from the said user, a criteria comprising of academic qualifications, accomplishments, interests and the like; 2. With the received inputs generating and displaying to the user a possible list of tasks suitable for the selected criteria, 3. receiving a selection of new task from the user; 4. accessing the users' database to generate the users' selected tasks' ‘task readiness indicator’ along with the relevant users' possessed subject matter and possible list of activities to achieve the said selected task and a list of relevant said task related information, for further exploration by the user; 5. enabling and supporting users' further exploration and launching the said users' selected activity; 6. Storing the entire activity related data and input data generated by the user in the said users' database. With such a system the user would quickly know his readiness of a new unexplored exam in spite of taking its mock test and the user would also be enlightened about the various types of other exams for which he is by default is ready for excelling, this would incite excitement, motivation, curiosity and metacognitive awareness about his preparation levels. By interacting in the above said method a student will gain awareness about various tasks the said users can take up or the said users' peers are taking up. With this awareness New opportunities will be propped up which the user has not considered or is not aware of. To support his investigation of these exams and various career paths can open up, suitable information links are displayed which when clicked would. take the user to corresponding information websites. By the disclosed method a users' need for knowing about various exams, career options, his readiness to accomplish them successfully and the various tasks one need to take up to achieve it is clearly displayed, hence the said user can make an informed decisions and choices leaving no room for assumptions.

Task level activities: Warming up for task accomplishment: In one embodiment where once a user is satisfied with his task accomplishment preparedness conveyed through task readiness indicator, the said user taking up warm-up activity is disclosed. Unlike a learning, reviewing, practicing or assessment, activity, warm up is a performance oriented activity wherein the said user would equip oneself with realistic confidence & metacogniton that will help in achieving the said task accomplishment. It is a summation of all activities one had performed so far comprehended in a preset allocated time set by the user or suggested by a algorithm. The computer would receive the criteria and generate crucial information to be displayed to the user. A typical warm-up session activity/method is conducted a few hours before performing the said task to achieve the said anticipated outcome of the said user in the said task by increasing the acquired mastery, performance and Metacognition awareness, comprising of: 1. receiving the criteria for warm-up including the time available for performing the said activity; 2. determining the data to be shown to the said user based on the available time and criteria for warm-up set by the said user 3. displaying to the user a set of comprehensive interactive information, the said interactive information may comprise of the said user interacting with the said interactive information through a GUI using an input device, for getting more insights, on his achieved subject matter so far by various activities the said user has performed, by accessing from the said users' database; 4. receiving an input from the said user confirming the said users' satisfaction level; 5. displaying the subject matter to be reviewed few hours before the said task by the said user as determined by a set of algorithms and presented to the said user by means of a set of activities like timed quizzes 6. on completion of the said activities, displaying to the said user, information strengthening and boosting the said users' Metacognition and confidence in helping the said user to approach with a realistic confidence to perform the task successfully. Hence this activity is a very crucial in protecting and maintaining the said users' composure at the time of extreme pressure.

Metacognition validation for any activity performed by use of the disclosed system is achieved by—(1) recording of a set of users' collective expectations and projected thoughts of the potential outcome of the said activity before conducting the said activity, (2) conducting the said activity by the said user, (3) If the said activity is of learning then conducting an e assessment to the said user for collecting responses on questions, pertaining to the said activity, (4) collecting the expectations and thoughts of the outcome on the already completed said activity, (5) receiving and storing the said information on a database, (6) comparing the difference in expectations and projected thoughts of the said user from the statistically analysed conclusions and indices from the collected data, (7) further comparing the said comparison with the said data collected from the said individual question answer responses recorded by the said user if available, (8) conveying the said difference by the computer to the user by means of indicators representing difference in the expectations of the user of his beliefs or Metacognition and the ground reality calculated by the computer in the said activity and said task pertinent subject matter; (9) further, conveying the related recommendations to the said user regarding present as well as future task pertinent activities to achieve improvement over the identified shortcomings.

By the use of disclosed system Metacognition development can be achieved by the said user at various levels of task accomplishment. At macro level, referring to the task based activities, it is achieved by a user monitoring ones' change of Validated beliefs, expectations, mastery, performance represented to him by means of indicators and displayed to him in the interactive visual database. A faster and accurate users' Metacognition development can be achieved by the following steps enabled and supported by the disclosed system: (1) displaying of indicators and recommendations to the user like educated guess ability, luck factor, gut factor, subject thoroughness, exam readiness, Trust your gut Recommendation and subject matter improvement strategy determination derived from the data recorded during various assessment activities conducted by the said user, (2) based on the said indicators displaying of subject matter segregated into knowledge contents that are classified into unknown, vantage, decayed, danger, known, mastered and aced group categories, (3) displaying a suggested ratio required to be maintained between acts resulting in mastery and expertise of the subject matter and the acts resulting in circumventing the need of mastery and expertise of the subject matter to achieve the said task by the said user (4) receiving of the said user's input about the said ratio and updating the said segregated groups of subject matter along with available activities for the said user to conduct and achieve the expected outcome of the said task (5) enabling the user to conduct said related activities; (6) tracking, monitoring, analysing the user's said related activities to calculate the improvement achieved and conveying it back to the said user; (7) repeating the steps till the user accomplishes the said task.

At micro level, referring to during e-assessment, Metacognition awareness indicator (114)—shows if a user is making conscious choices or not and how accurate those informed choices are. In one embodiment, at the beginning of the test Metacognition indicator would be ‘0’ and as the user answers different questions the Metacognition indicator value start building up. Every answer choice carries a pre defined value that indicates the quality of the answer input. Higher the quality of the answer input, higher the Metacognition awareness, value for that answer input would be and vice versa. The task of the user is to always keep the indicator positive and as high as possible by giving high quality answer inputs. For example A high quality answer input is defined as that input where the user has selected an answer from A1 column within a duration less than a preset time limit and his answer pick turns to be a correct answer. A Metacognition awareness value of 1 is awarded to the student. A low quality answer input is defined as that input where user has selected an answer from A1 column within a, time less than a preset time limit and his answer pick turns to be a wrong answer. A meta cognition awareness value of ‘˜10’ is awarded to the student. Different other grades of values are assigned to other shades of answer inputs between high and lower quality answer inputs. Thus, the student will have to be aware of the quality of answer inputs he would provide in order to keep the Metacognition indicator high. The Metacognition indicator value and the total score in a test are 2 different entities. The values might be or might not be the same but the total score would tell how a student has performed in a test and the Metacognition indicator will reveal information on a student's awareness of his knowledge, skill, ability and personal traits.

The disclosed answer recording method, assessment GUI, task accomplishment system, and methods for efficient task accomplishment positions assessment at heart of learning and are reliable, valid, fair and consistent as it is not based on assumptions but on direct and explicit inputs by the student, hence, gives a realistic picture of his preparation level enabling preparing for a task accomplishment in a very efficient way and in shortest possible duration.

1. A computer assisted answer recording method for e-learning, or e-assessment comprising:
a. recording an answer choice by the user of the said method for an objective type question by an answer selection submitting input action or by a marking action made on an said answer choices' answer choice input receiving element, the said action being integrated concurrently instantly with the same action with quantified parameters of the said users' means of arriving at an answer choice and or of reasons, feelings, thoughts, & needs recorded simultaneously or instantly by the said user as and when they have arisen in the mind of the said user while solving the said question & choosing the said answer choice;
b. feeding the said integrated input to a computer programme that would analyse the results and transform them into statistical indices of performance parameters in a quantified way in reference to the said question and said test information and display the said statistical indices to the user automatically or as and when desired by the user.

2. A method of claim 1 wherein the said answer choice input receiving element displayed in the graphic user interface for the said answer choice can be any one or more of following:
a. of any shape, word, sentence, numerical, 3d form, colour, value, sound;
b. displayed with other answer choices' input receiving elements of the said question, or with other input receiving elements of the same answer choice for the said question where in, each of the said one or more said answer input receiving elements can represent a means or type of answer pick corresponding to educated guess pick, random pick, gut pick, logic pick, confident pick, revision required pick or no response pick;
c. arranged in any visible formation within the displayed graphic user interface, where in the visibility value can be set to any value between zero, meaning invisible or 1 meaning fully visible, inclusive, and the said visibility state can be changed by movement of a cursor on the displayed said GUI or by pressing keys on the key board.

3. A method of claim 1 wherein the said integration of the said parameters with the said answer with the said answer selection inputting or marking action is achieved by encoding of Graphic User Interface (GUI) answer choice input receiving elements or by encoding various keys in the keyboard or by encoding of cursor movements on the GUI or by encoding a combination of GUI answer choice input receiving elements & various keys in the keyboard with quantified parameters, and integrating the said chosen parameters by the said user with the said answer selection inputting action that records the said users' answer choice and or by a an action made by the said user for selection of the specific parameters.

4. Data generated through the method as recited in claim 1 for further use.

5. A method of claim 1 where in the said answer recording method is used on a GUI comprising means for said answer recording method alone or at least one or more of the question stem or answer choices or answer choices input marking elements or tag names of selected parameters or progress indicators or space for adding personal notes or a display of information like text, picture, voice or video.

6. A computer assisted method of claim 1 of learning for or of accomplishing a task by user of the said method comprising:
a. a means for developing self evaluation on the said task by the said user,
b. a means for verification by the software of statistical analysis embedded in the computer of the validity of the users' task self evaluation and displaying the ground reality in the form of statistically analysed indices, identifying possible ways of improvement in terms of improvement in mastery over the subject matter or prospects of success in reliance on alternative personal traits of the user including educated guess ability, gut factor and luck factor;
c. a means for displaying projections prepared by the computer on various prospects or opportunities the said accomplishment of the said task would provide to the said user as a means to motivate the said user to accomplish the said task successfully;
d. a means for enabling the said user in conducting and repeating the self evaluation, learning activities, testing his preparedness by undertaking an e-assessment of claim 1 to improve upon the relevant shortcomings and weakness;
e. a means for equipping the said user with validated and quantified assessment of his preparedness for performing the said task in an examination or a performance of his knowledge in real life.

7. A method of claim 6 wherein:
a. the said task comprises use or performance of at least one of the user's task relevant subject matter comprising his existing Knowledge or Ability or Skill or Aptitude or personal traits or Metacognition awareness or metacognition regulation;
b. the said self evaluation pertains to one or more of (i) the said users' own capability, (ii) state of preparedness to accomplish the task, (iii) user's perception on how and when a task is conducted, (iv) user's perceived likelihood of accomplishing success, (v) user's perception on different means of learning and performing activities available for the task.

8. A method of claim 1 comprising at least one of the following:
a. a means for e-assessment comprising steps of
i. accessing the participating e-testing and e-assessment platforms' relevant question databases and generating the mock test based on users' selection of exam;
ii. displaying to the said user a GUI enabled with the said answer recording method;
iii. presenting a question to the user;
iv. receiving an answer choice by the said user comprising the method as recited in the process of recording the said answer choice by the said user by a answer selection inputting action or marking action through an inputting device wherein the inputting or marking action is also integrated with the said users' own thought process comprising of beliefs of his own or psychological preparedness or a need thereof, the reasoning behind choosing the said particular answer prior to or at the time of recording the said answer choice by the said users inputting action;
v. decoding of the response input by the said computer and storing it in the said database and making it available for the respective e-testing and e-assessment platform;
or
b. a means for Metacognition validation comprising steps of
i. recording of a set of a users' collective expectations and projected thoughts of the potential outcome of the said activity before conducting the said activity;
ii. enabling conducting of the said activity by the said user;
iii. If the said activity is of learning then conducting an e assessment as recited in claim 8.a to the said user for collecting the users' responses on questions pertaining to the said activity;
iv. collecting the expectations and thoughts of the outcome on the already completed said activity;
v. receiving and storing the said information on a database;
vi. comparing the difference in expectations and projected thoughts of the said user from the statistically analysed conclusions and indices from the collected data;
vii. further comparing the said comparison with the said data collected from the said individual question answer responses recorded by the said user if available;
viii. conveying the said difference by the computer to the user by means of indicators representing difference in the expectations of the user of his beliefs or metacognition and the ground reality calculated by the computer in the said activity and said task pertinent subject matter;
ix. further, conveying the related recommendations to the said user regarding present as well as future task pertinent activities to achieve improvement over the identified shortcomings;
or
c. a means for Metacognition development comprising:
i. displaying of indicators and recommendations to the user like educated guess ability, tuck factor, gut factor, subject thoroughness, exam readiness, Trust your gut Recommendation and subject matter improvement strategy determination derived from the data recorded during various assessment activities conducted by the said user;
ii. based, on the said indicators displaying of subject matter segregated into knowledge contents that are classified into unknown, vantage, decayed, danger, known, mastered and aced group categories;
iii. displaying a suggested ratio required to be maintained between acts resulting in mastery and expertise of the subject matter and the acts resulting in circumventing the need of mastery and expertise of the subject matter to achieve the said task by the said user;
iv. receiving of the said user's input about the said ratio and updating the said segregated groups of subject matter along with available activities for the said user to conduct and achieve the expected outcome of the said task;
v. enabling the user to conduct said related activities;
vi. tracking, monitoring, analysing the user's said related activities to calculate the improvement achieved and conveying it back to the said user;
vii. repeating the steps till the user accomplishes the said task;
or
d. a means for warm-up session activity/method conducted a few hours before performing the said task to achieve the said anticipated outcome of the said user in the said task, comprising of:
i. receiving the criteria for warm-up including the time available for performing the said activity;
ii. determining the data to be shown to the said user based on the available time and criteria for warm-up set by the said user;
iii. displaying to the user a set of comprehensive interactive information, the said interactive information may comprise of the said user interacting with the said interactive information through a GUI using an input device, for getting more insights, on his achieved subject matter so far by various activities the said user has performed by accessing from the said users' database;
iv. receiving an input from the said user confirming the said users' satisfaction level;
v. displaying the subject matter to be reviewed few hours before the said task by the said user as determined by a set of algorithms and presented to the said user by means of a set of activities like timed quizzes;
vi. on completion of the said activities, displaying to the said user, information strengthening and boosting the said users' Metacognition and confidence in helping the said user to approach with a realistic confidence to perform the task successfully;
or
e. a means for the user to develop task awareness of the said task comprising:
i. receiving from the said user, the said users' criteria, the said criteria may comprise of academic qualifications, accomplishments and interests;
ii. on receiving the said inputs displaying the said user a GUI containing possible list of tasks suitable for the said users' said criteria;
iii. receiving from the said user a selection of new task froth the said displayed list of tasks;
iv. on receiving the said user selection, accessing the said users' database to generate the said users' said task related task readiness indicator along with the relevant said users' possessed subject matter and possible list of activities to achieve the said selected task and a list of relevant said task related information, for the said user's further exploration;
v. receiving from the said user an input for further exploration and launching the said users' selected activity;
vi. storing all of the said user generated activity related data and input data in the said user database;
or
f. a means for a user to instantly build subject matter awareness on a symbol or numerical or character or shape or word or a diagram or a picture, or a group of symbols/numerical/character/shape/word/diagram/picture comprising carrying a machine readable encoding displayed to the said user on a GUI connected to the network system, while performing an task related activity, the said means comprising:
i. displaying of Pop up window on the onset of the said user clicking on a symbol or numerical or character or shape or word or a diagram or a picture, or a group of symbols/numerical/character/shape/word/picture/diagram carrying a machine readable encoding, appearing anywhere within the said plurality of GUIs connected to the said network system from the said user;
ii. displaying pertinent information related to the said symbol or numerical or character or shape or word or a diagram or a picture, or a group of symbols/numerical/character/shape/word/picture/diagram in the pop up window;
iii. receiving and recording custom content created or uploaded by the said user related to the said symbol or numerical or character word or shape or a group of symbols, numerical character, word, carrying a machine readable encoding;
iv. saving the new information in the said users' database;
v. retrieving and displaying the recorded information to the said user in future on the said user's explicit request;
or
g. a means for facilitating the said user conduct the said task related offline activities or online activities through the said network system, comprising:
i. displaying a GUI containing visually represented groups of data containing the said task and the said user's pertinent subject matter with indicators, task related information, associated inbuilt and third party activities applications;
ii. receiving various task and activity pertinent inputs either from the said user or from the said user's tutor or an algorithm;
iii. updating the said groups of data dynamically;
iv. receiving an input from the said user as a selection on one of the said displayed activities for a said group of data;
v. launching the said activity enabling the user to perform the said activity with related groups' subject matter;
vi. monitoring the user activity;
vii. updating the said groups of data based on outcomes of the said activity by the said user;
viii. Indicating a visual prompt, generated by a algorithm considering the said users' said mastery and performance ratio, on one of the said groups of data attracting users' attention for the next proposed said task based activity.
